(19) United States
(12) Patent Application Publication
(10) Pub. No.: US 2018/0011336 A1
(43) Pub. Date: Jan. 11, 2018

(54) ZOOM LENS AND IMAGE PICKUP APPARATUS INCLUDING THE SAME

(71) Applicant: CANON KABUSHIKI KAISHA, Tokyo (JP)

(72) Inventor: Norihiro Nanba, Utsunomiya-shi (JP)

(21) Appl. No.: 15/547,690

(22) PCT Filed: Mar. 30, 2016
(86) PCT No.: PCT/JP2016/061184

§ 371 Date: Jul. 31, 2017

(30) Foreign Application Priority Data
Apr. 21, 2015 (JP) 2015-086634

(51) Int. Cl. G02B 27/64; G03B 5/02; G02B 13/00; G03B 5/04; G02B 15/20

(52) U.S. Cl. CPC G02B 27/646; G03B 5/04; G02B 15/20; G02B 13/009; G03B 5/02; G03B 2205/0015; G03B 2205/0046

(57) ABSTRACT

Provided is a zoom lens, including, in order from an object side: first positive, second negative, third positive lens units, and rear lens group, in which intervals between the first and second lens units, between the second and third lens units, and between the third lens unit and the rear lens group, are respectively is increased, decreased and changed, in which the zoom lens includes an image stabilization unit A configured to move not in an optical axis direction during image blur correction, and an image stabilization unit B configured to rotate around a point on or near the optical axis during the image stabilization, and in which focal lengths of the image stabilization unit B and the zoom lens, maximum value θt of image blur correction angle, and rotation angle of the image stabilization unit B upon the image blur correction angle θt are appropriately set.

### TECHNICAL FIELD

The present invention relates to a zoom lens and an image pickup apparatus including the same, which are suitable for an image pickup apparatus using an image pickup element, such as a video camera, an electronic still camera, a broadcasting camera, or a monitoring camera, or an image pickup apparatus such as a silver halide film camera.

### BACKGROUND ART

A zoom lens having a high zoom ratio and a high optical characteristic is required for a photographing optical system for use in an image pickup apparatus. The zoom lens having a high zoom ratio has a tendency that in general, the entire system becomes large and the weight becomes heavy. When the zoom lens becomes large in size and heavy in weight, the zoom lens is vibrated due to camera shake or the like during the photographing in many cases. When the zoom lens is tilted by the vibration, a captured image (image forming position) is shifted by an amount corresponding to a tilt angle of the zoom lens and a focal length at that time to cause an image blur.

There is known a zoom lens in which a part of a lens system is shifted in a direction perpendicular to an optical axis as a measure to correct the image blur. In Patent Literature 1, there is described a zoom lens including, in order from an object side, first to fourth lens units having positive, negative, positive, and positive refractive powers, respectively, in which the image blur is corrected by shifting the third lens unit. In Patent Literature 2, there is disclosed a zoom lens including, in order from an object side to an image side, first to fifth lens units having positive, negative, positive, negative, and positive refractive powers, respectively, in which the image blur is corrected by shifting the fourth lens unit.

There is also known a zoom lens in which, in order to reduce decentering aberration, which occurs in correcting the image blur, a lens unit forming a part of a lens system is configured to be shifted in a direction perpendicular to an optical axis and to be rotated with one point on the optical axis being a center of rotation. In Patent Literature 3, there is described a zoom lens including, in order from an object side to an image side, first to fourth lens units having positive, negative, positive, and positive refractive powers, respectively, in which the second lens unit is configured to be shifted and tilted to perform image blur correction.

There is further known a zoom lens in which, in order to reduce the decentering aberration in correcting the image blur, a plurality of lens units in a lens system are configured to be shifted in a direction perpendicular to an optical axis. In Patent Literature 4, there is disclosed a zoom lens including, in order from an object side to an image side, first to fifth lens units having positive, negative, positive, negative, and positive refractive powers, respectively, in which a plurality of lens units, that is, the second lens unit and the fourth lens unit, or the third lens unit and the fifth lens unit are configured to be shifted to perform image blur correction.

There is further known a zoom lens in which, in order to reduce decentering aberration, which occurs in correcting the image blur, a lens unit forming a part of a lens system is configured to be shifted in a direction perpendicular to an optical axis and another lens unit is configured to be rotated around one point on the optical axis. In Patent Literature 5, there is described a zoom lens including, in order from an object side to an image side, first to fifth lens units having positive, negative, positive, negative, and positive refractive powers, respectively, in which the fourth lens unit is configured to be shifted to perform image blur correction, and in which the second lens unit is configured to be rotated to correct decentering aberration. In Patent Literature 5, there is also described a zoom lens including, in order from an object side to an image side, lens units having positive, negative, positive, negative, and positive refractive powers, respectively, in which the second lens unit is configured to be shifted to perform image blur correction, and in which lenses forming a part of the third lens unit are configured to be rotated to correct decentering aberration.

### CITATION LIST

### Patent Literature

PTL 1: Japanese Patent Application Laid-Open No. H10-260356

PTL 2: Japanese Patent Application Laid-Open No. H10-090601

PTL 3: Japanese Patent Application Laid-Open No. H05-232410

PTL 4: Japanese Patent Application Laid-Open No. 2001-249276

PTL 5: Japanese Patent Application Laid-Open No. 2003-202499

### SUMMARY OF INVENTION

### Technical Problem

In general, in order to precisely carry out the image blur correction and reduce an aberration variation during the image blur correction in the zoom lens having an image stabilization function, it is important to appropriately set a lens configuration of the zoom lens, a lens configuration of the image stabilization unit for the image blur correction, and the like. If the lens configuration of the image stabilization unit, which is moved for the image blur correction, and the lens configuration of the image stabilization unit, which is moved for the aberration correction, are not proper, it becomes difficult to maintain a high optical characteristic during the vibration compensation.

### Solution to Problem

According to one embodiment of the present invention, there is provided a zoom lens, including, in order from an object side to an image side:

a first lens unit having a positive refractive power;

a second lens unit having a negative refractive power;

a third lens unit having a positive refractive power; and

a rear lens group including at least one lens unit,

in which, during zooming from a wide angle end to a telephoto end, an interval between each pair of adjacent lens units is changed so that an interval between the first lens unit and the second lens unit is increased, an interval between the second lens unit and the third lens unit is reduced, and an interval between the third lens unit and the rear lens group is changed,

in which the zoom lens includes an image stabilization unit A configured to move so as to have a component in a direction perpendicular to an optical axis during image blur correction, and an image stabilization unit B configured to be rotated around one of one point on the optical axis and one point near the optical axis along with the movement of the image stabilization unit A, and

in which the following conditional expressions are satisfied:

0.01<|fB|/ft<0.35; and

0.85<|TBt|/θt<10.00,

where fB represents a focal length of the image stabilization unit B, ft represents a focal length of the zoom lens at the telephoto end, θt represents a maximum value of an image blur correction angle at the telephoto end, and TBt represents a rotation angle of the image stabilization unit B when the image blur correction at the image blur correction angle θt is performed at the telephoto end.

Further features of the present invention will become apparent from the following description of exemplary embodiments with reference to the attached drawings.

### BRIEF DESCRIPTION OF DRAWINGS

FIG. 1A is a lens cross-sectional view at a wide angle end according to Embodiment 1 of the present invention.

FIG. 1B is a lens cross-sectional view at an intermediate zoom position according to Embodiment 1.

FIG. 1C is a lens cross-sectional view at a telephoto end according to Embodiment 1.

FIG. 2A is a longitudinal aberration diagram at the wide angle end according to Embodiment 1.

FIG. 2B is a longitudinal aberration diagram at the intermediate zoom position according to Embodiment 1.

FIG. 2C is a longitudinal aberration diagram at the telephoto end according to Embodiment 1.

FIG. 3A is a lateral aberration diagram at the wide angle end according to Embodiment 1.

FIG. 3B is a lateral aberration diagram at the intermediate zoom position according to Embodiment 1.

FIG. 3C is a lateral aberration diagram at the telephoto end according to Embodiment 1.

FIG. 4A is a lateral aberration diagram at the wide angle end during an image blur correction according to Embodiment 1.

FIG. 4B is a lateral aberration diagram at the intermediate zoom position during the image blur correction according to Embodiment 1.

FIG. 4C is a lateral aberration diagram at the telephoto end during the image blur correction according to Embodiment 1.

FIG. 5A is a lens cross-sectional view at a wide angle end according to Embodiment 2 of the present invention.

FIG. 5B is a lens cross-sectional view at an intermediate zoom position according to Embodiment 2.

FIG. 5C is a lens cross-sectional view at a telephoto end according to Embodiment 2.

FIG. 6A is a longitudinal aberration diagram at the wide angle end according to Embodiment 2.

FIG. 6B is a longitudinal aberration diagram at the intermediate zoom position according to Embodiment 2.

FIG. 6C is a longitudinal aberration diagram at the telephoto end according to Embodiment 2.

FIG. 7A is a lateral aberration diagram at the wide angle end according to Embodiment 2.

FIG. 7B is a lateral aberration diagram at the intermediate zoom position according to Embodiment 2.

FIG. 7C is a lateral aberration diagram at the telephoto end according to Embodiment 2.

FIG. 8A is a lateral aberration diagram at the wide angle end during an image blur correction according to Embodiment 2.

FIG. 8B is a lateral aberration diagram at the intermediate zoom position during the image blur correction according to Embodiment 2.

FIG. 8C is a lateral aberration diagram at the telephoto end during the image blur correction according to Embodiment 2.

FIG. 9A is a lens cross-sectional view at a wide angle end according to Embodiment 3 of the present invention.

FIG. 9B is a lens cross-sectional view at an intermediate zoom position according to Embodiment 3.

FIG. 9C is a lens cross-sectional view at a telephoto end according to Embodiment 3.

FIG. 10A is a longitudinal aberration diagram at the wide angle end according to Embodiment 3.

FIG. 10B is a longitudinal aberration diagram at the intermediate zoom position according to Embodiment 3.

FIG. 10C is a longitudinal aberration diagram at the telephoto end according to Embodiment 3.

FIG. 11A is a lateral aberration diagram at the wide angle end according to Embodiment 3.

FIG. 11B is a lateral aberration diagram at the intermediate zoom position according to Embodiment 3.

FIG. 11C is a lateral aberration diagram at the telephoto end according to Embodiment 3.

FIG. 12A is a lateral aberration diagram at the wide angle end during an image blur correction according to Embodiment 3.

FIG. 12B is a lateral aberration diagram at the intermediate zoom position during the image blur correction according to Embodiment 3.

FIG. 12C is a lateral aberration diagram at the telephoto end during the image blur correction according to Embodiment 3.

FIG. 13A is a lens cross-sectional view at a wide angle end according to Embodiment 4 of the present invention.

FIG. 13B is a lens cross-sectional view at an intermediate zoom position according to Embodiment 4.

FIG. 13C is a lens cross-sectional view at a telephoto end according to Embodiment 4.

FIG. 14A is a longitudinal aberration diagram at the wide angle end according to Embodiment 4.

FIG. 14B is a longitudinal aberration diagram at the intermediate zoom position according to Embodiment 4.

FIG. 14C is a longitudinal aberration diagram at the telephoto end according to Embodiment 4.

FIG. 15A is a lateral aberration diagram at the wide angle end according to Embodiment 4.

FIG. 15B is a lateral aberration diagram at the intermediate zoom position according to Embodiment 4.

FIG. 15C is a lateral aberration diagram at the telephoto end according to Embodiment 4.

FIG. 16A is a lateral aberration diagram at the wide angle end during an image blur correction according to Embodiment 4.

FIG. 16B is a lateral aberration diagram at the intermediate zoom position during the image blur correction according to Embodiment 4.

FIG. 16C is a lateral aberration diagram at the telephoto end during the image blur correction according to Embodiment 4.

FIG. 17A is a lens cross-sectional view at a wide angle end according to Embodiment 5 of the present invention.

FIG. 17B is a lens cross-sectional view at an intermediate zoom position according to Embodiment 5.

FIG. 17C is a lens cross-sectional view at a telephoto end according to Embodiment 5.

FIG. 18A is a longitudinal aberration diagram at the wide angle end according to Embodiment 5.

FIG. 18B is a longitudinal aberration diagram at the intermediate zoom position according to Embodiment 5.

FIG. 18C is a longitudinal aberration diagram at the telephoto end according to Embodiment 5.

FIG. 19A is a lateral aberration diagram at the wide angle end according to Embodiment 5.

FIG. 19B is a lateral aberration diagram at the intermediate zoom position according to Embodiment 5.

FIG. 19C is a lateral aberration diagram at the telephoto end according to Embodiment 5.

FIG. 20A is a lateral aberration diagram at the wide angle end during an image blur correction according to Embodiment 5.

FIG. 20B is a lateral aberration diagram at the intermediate zoom position during the image blur correction according to Embodiment 5.

FIG. 20C is a lateral aberration diagram at the telephoto end during the image blur correction according to Embodiment 5.

FIG. 21 is an explanatory view for illustrating a rotation mechanism of the present invention.

FIG. 22 is a schematic view for illustrating a main part of an image pickup apparatus of the present invention.

### DESCRIPTION OF EMBODIMENTS

Now, exemplary embodiments of the present invention are described in detail with reference to the attached drawings. A zoom lens of the present invention includes, in order from an object side to an image side, a first lens unit having a positive refractive power, a second lens unit having a negative refractive power, a third lens unit having a positive refractive power, and a rear lens group including one or more lens units. During zooming from a wide angle end to a telephoto end, an interval between each pair of adjacent lens units is changed so that an interval between the first lens unit and the second lens unit is increased, an interval between the second lens unit and the third lens unit is decreased, and an interval between the third lens unit and the rear lens group is changed.

An image stabilization unit A configured to move so as to have a component in a direction perpendicular to an optical axis during image blur correction, and an image stabilization unit B configured to be rotated around one point on or near the optical axis along with the movement of the image stabilization unit A are included.

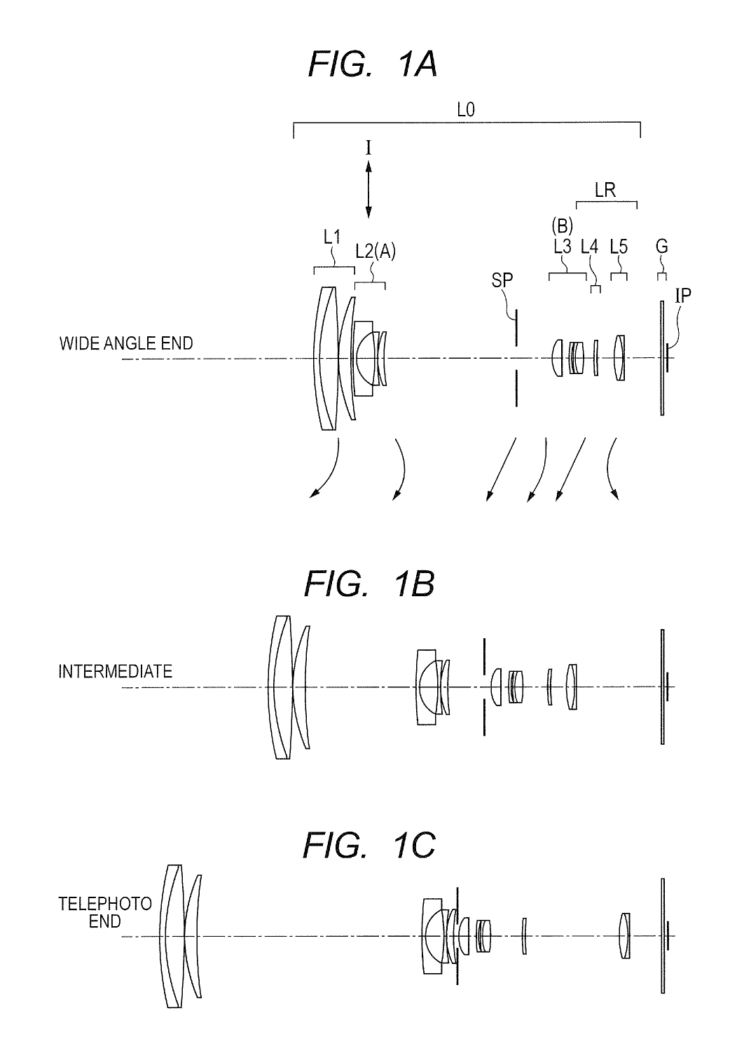

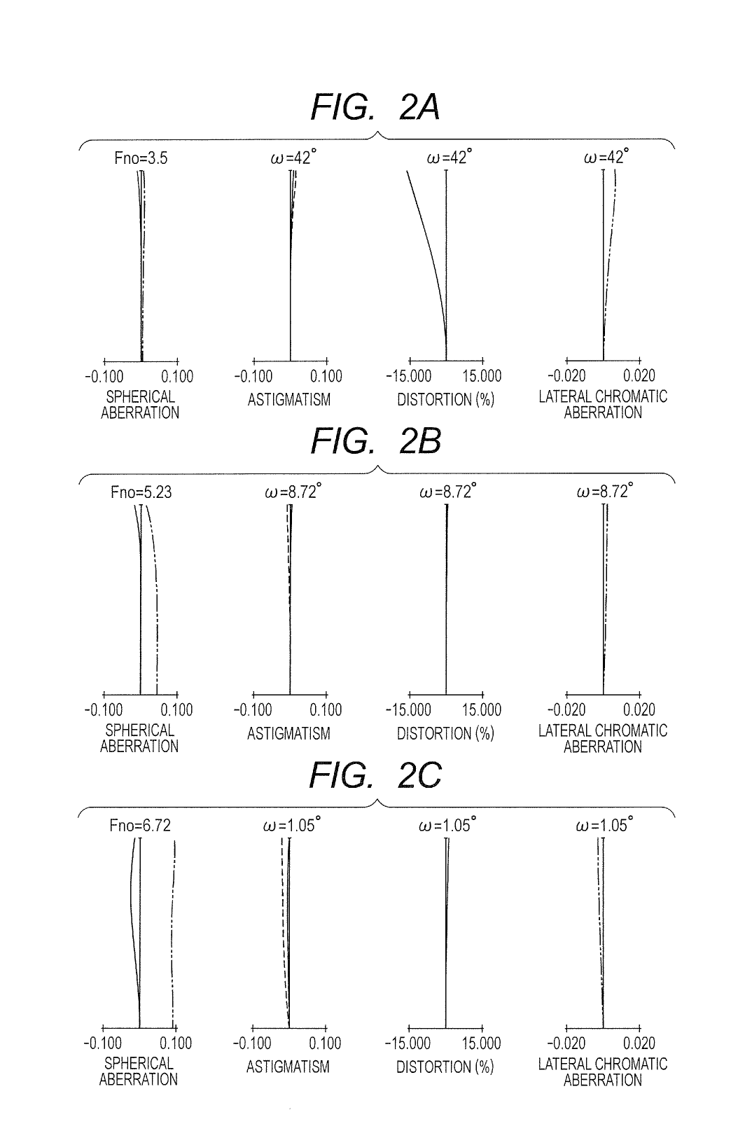

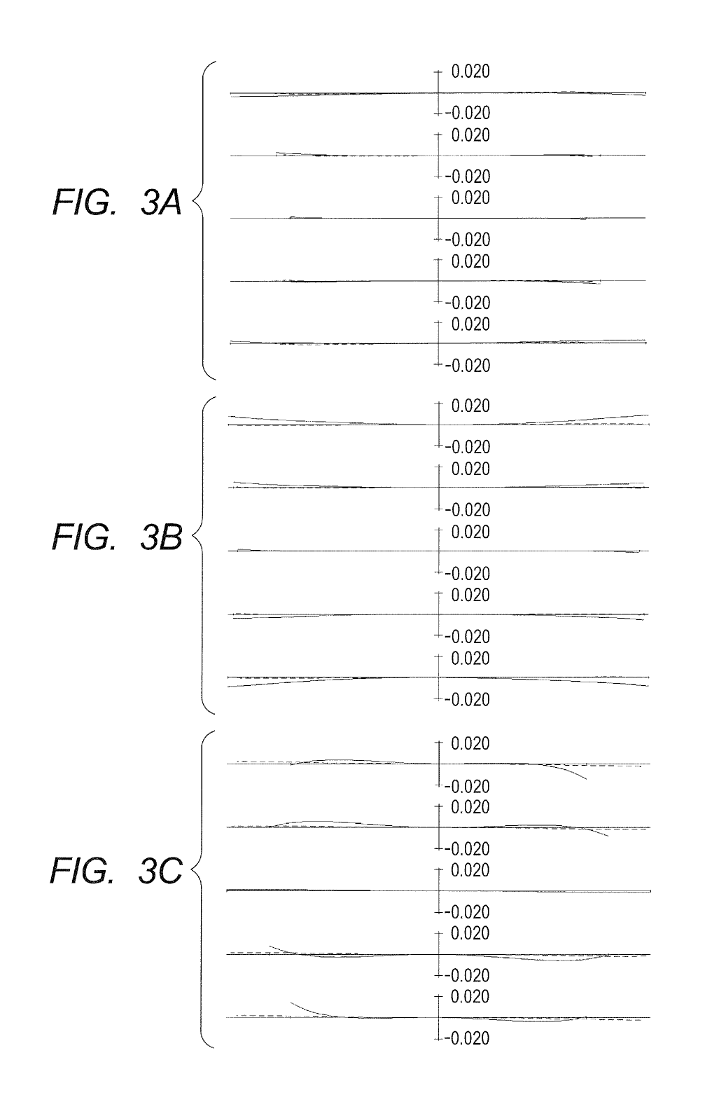

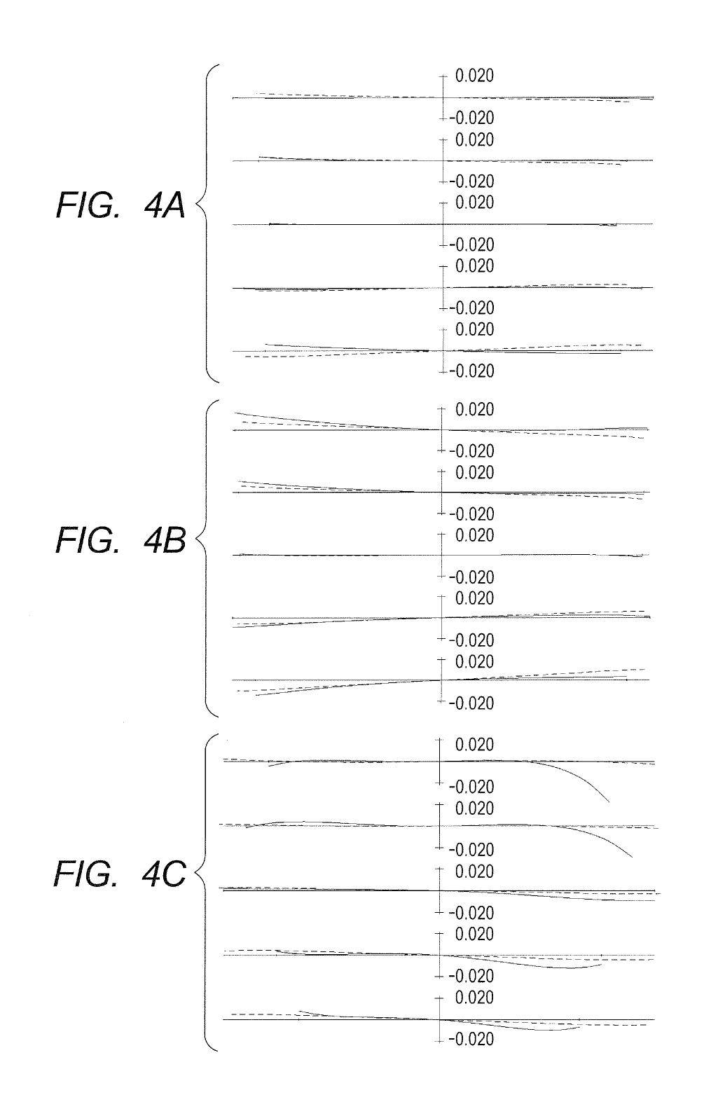

FIG. 1A, FIG. 1B, and FIG. 1C are respectively lens cross-sectional views at a wide angle end, at an intermediate zoom position, and at a telephoto end of Embodiment 1 of the present invention. FIG. 2A, FIG. 2B, and FIG. 2C are respectively longitudinal aberration diagrams at the wide angle end, at the intermediate zoom position, and at the telephoto end of Embodiment 1 of the present invention. FIG. 3A, FIG. 3B, and FIG. 3C are respectively lateral aberration diagrams at the wide angle end, at the intermediate zoom position, and at the telephoto end of Embodiment 1 of the present invention. FIG. 4A, FIG. 4B, and FIG. 4C are lateral aberration diagrams of Embodiment 1 of the present invention during the image blur correction at the wide angle end, the intermediate zoom position, and the telephoto end, respectively. Embodiment 1 is the zoom lens having a zoom ratio of approximately 47.49 and an aperture ratio (f-number) of from 3.50 to 6.72.

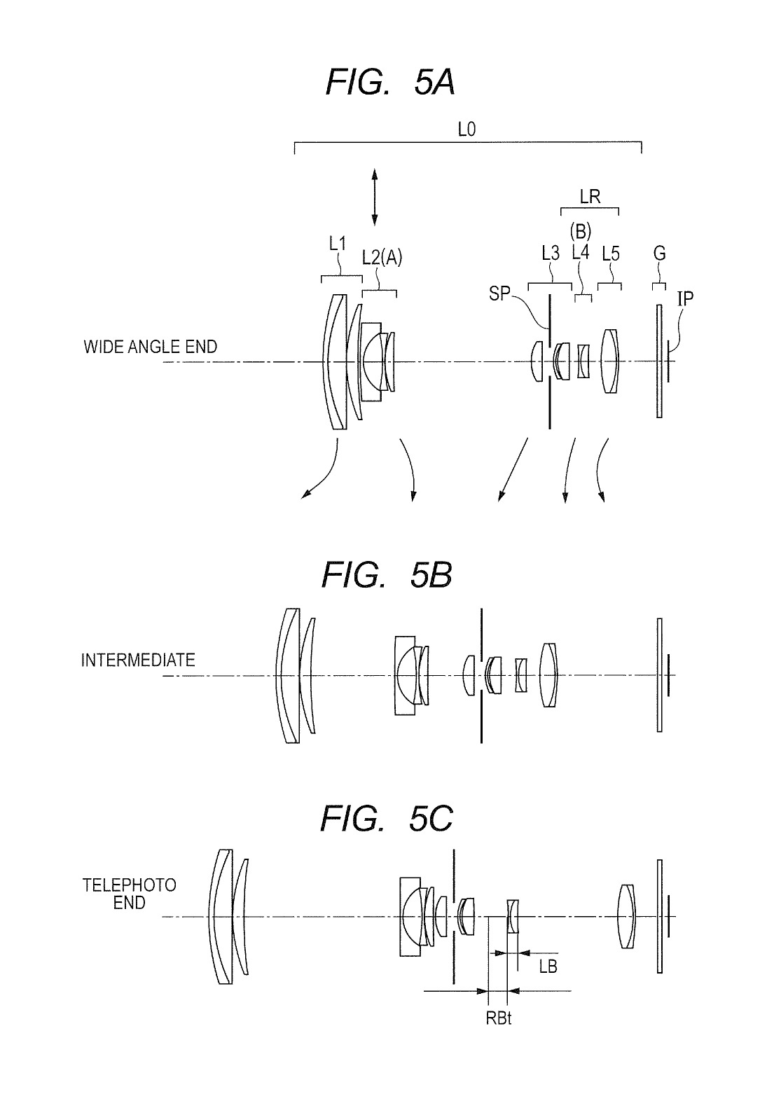

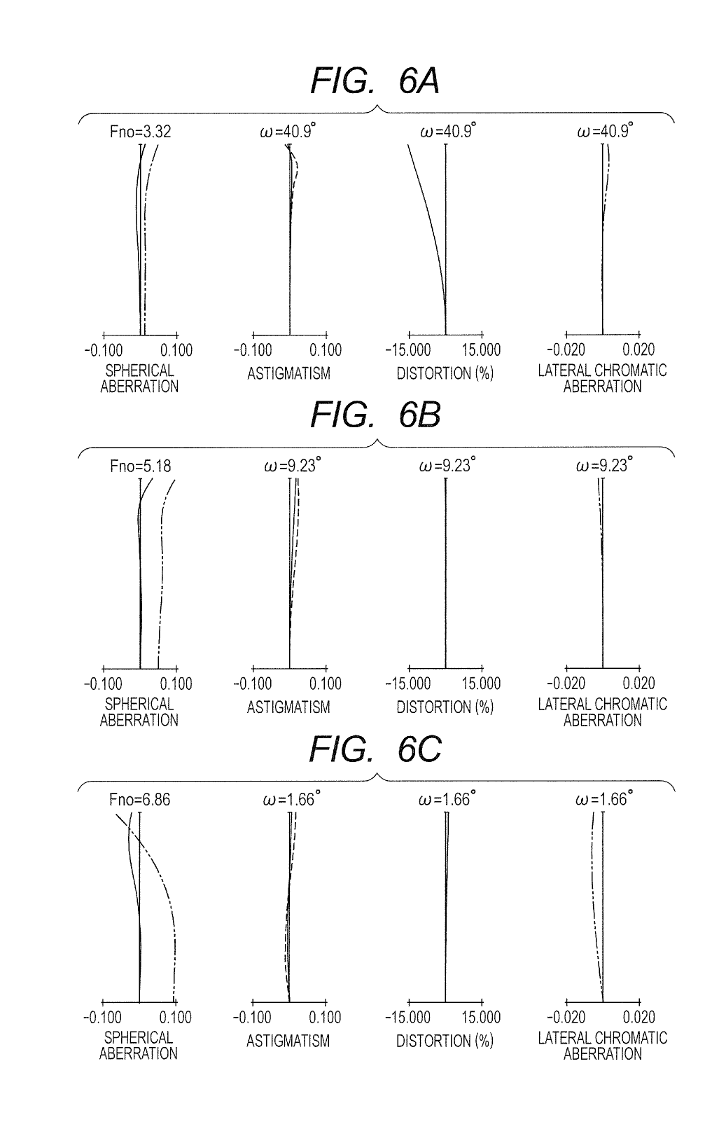

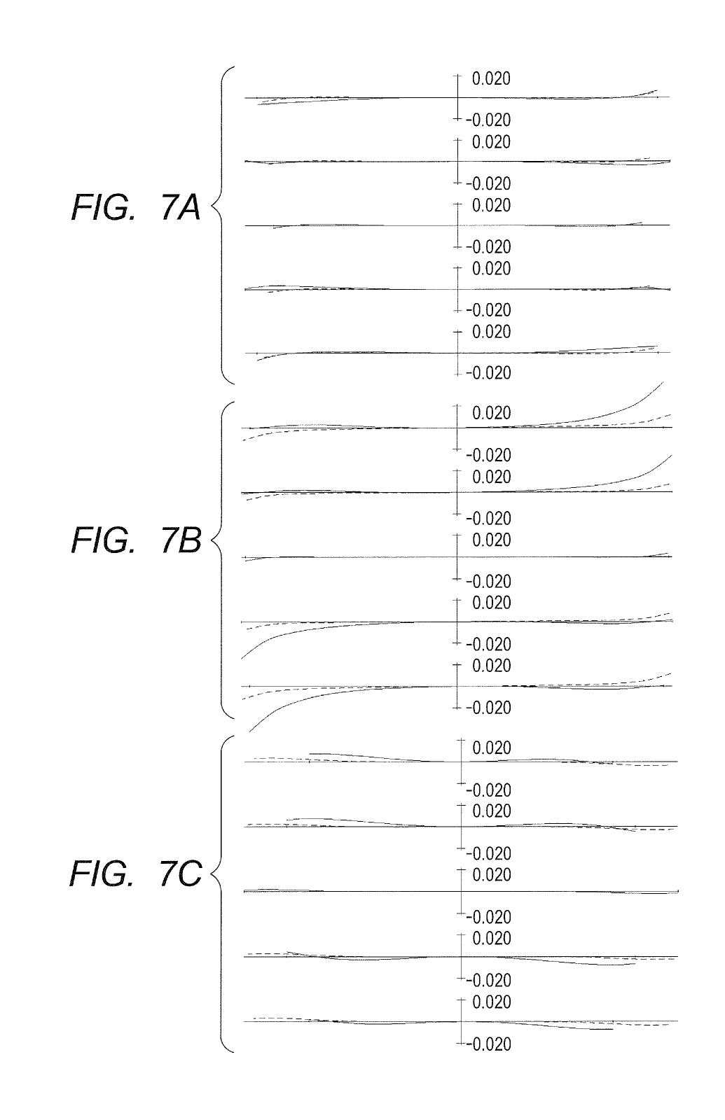

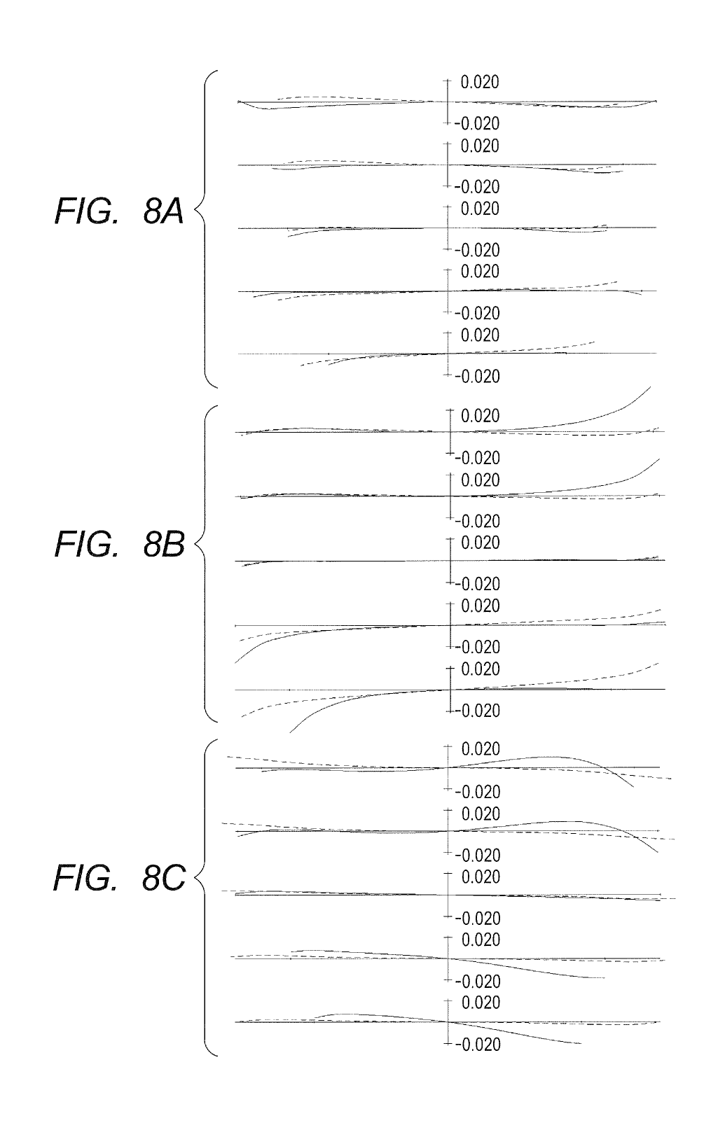

FIG. 5A, FIG. 5B, and FIG. 5C are respectively lens cross-sectional views at a wide angle end, at an intermediate zoom position, and at a telephoto end of Embodiment 2 of the present invention. FIG. 6A, FIG. 6B, and FIG. 6C are respectively longitudinal aberration diagrams at the wide angle end, at the intermediate zoom position, and at the telephoto end of Embodiment 2 of the present invention. FIG. 7A, FIG. 7B, and FIG. 7C are respectively lateral aberration diagrams at the wide angle end, at the intermediate zoom position, and at the telephoto end of Embodiment 2 of the present invention. FIG. 8A, FIG. 8B, and FIG. 8C are lateral aberration diagrams of Embodiment 2 of the present invention during the image blur correction at the wide angle end, the intermediate zoom position, and the telephoto end, respectively. Embodiment 2 is the zoom lens having a zoom ratio of approximately 28.93 and an aperture ratio (f-number) of from 3.32 to 6.86.

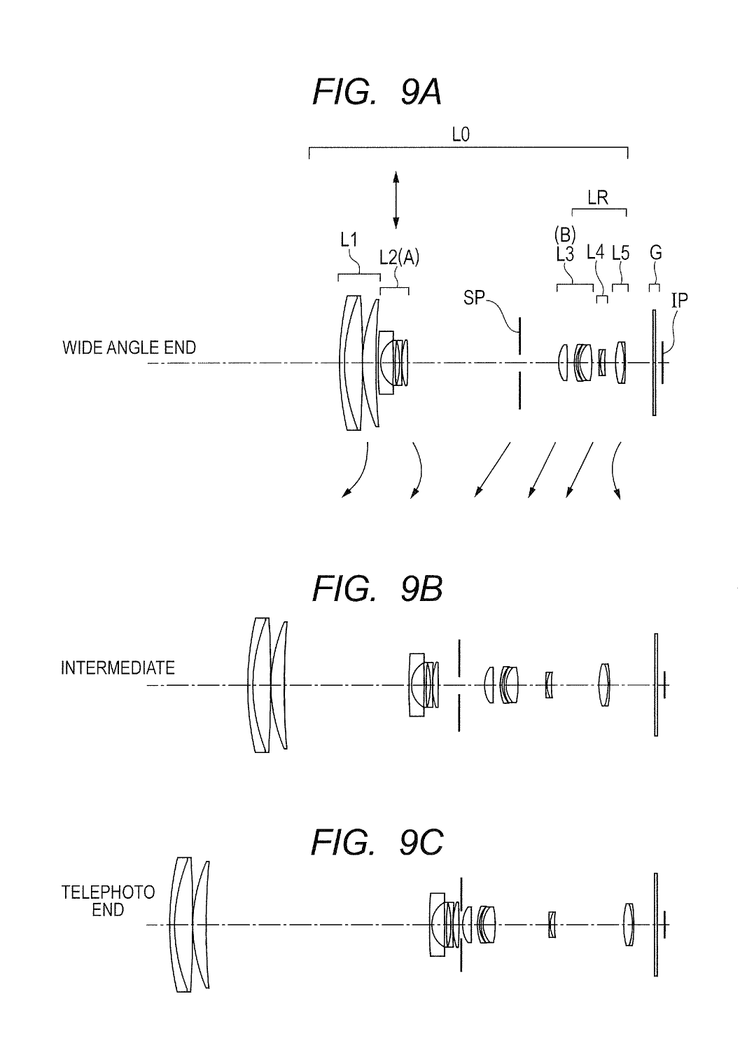

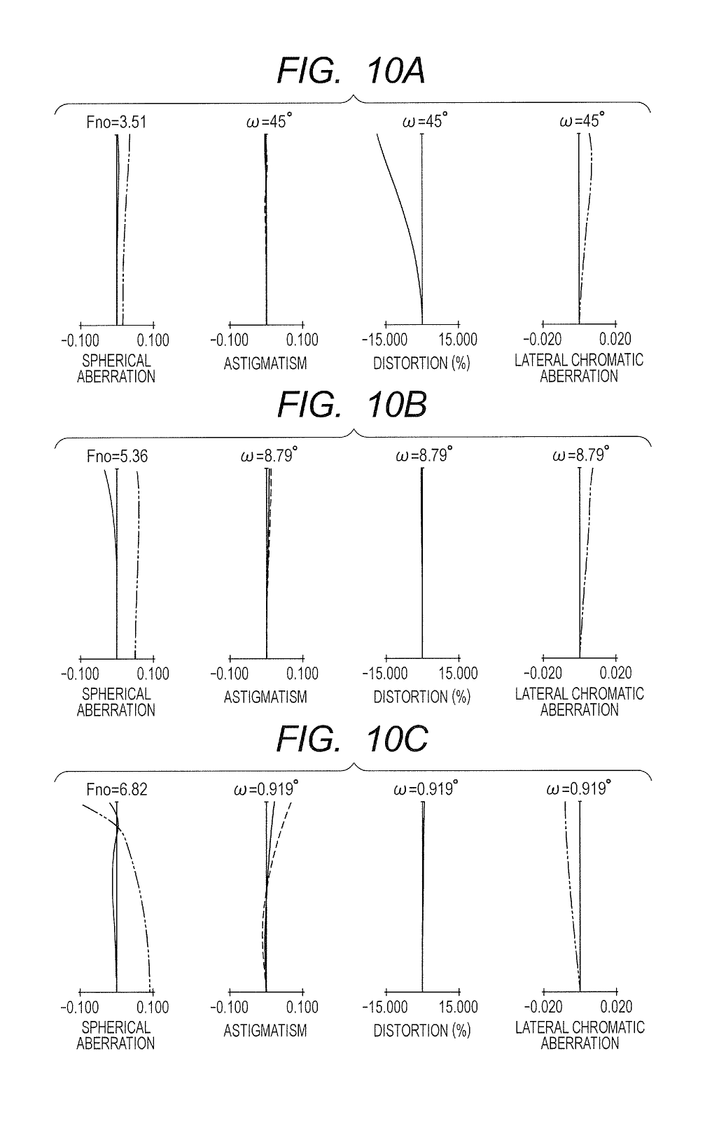

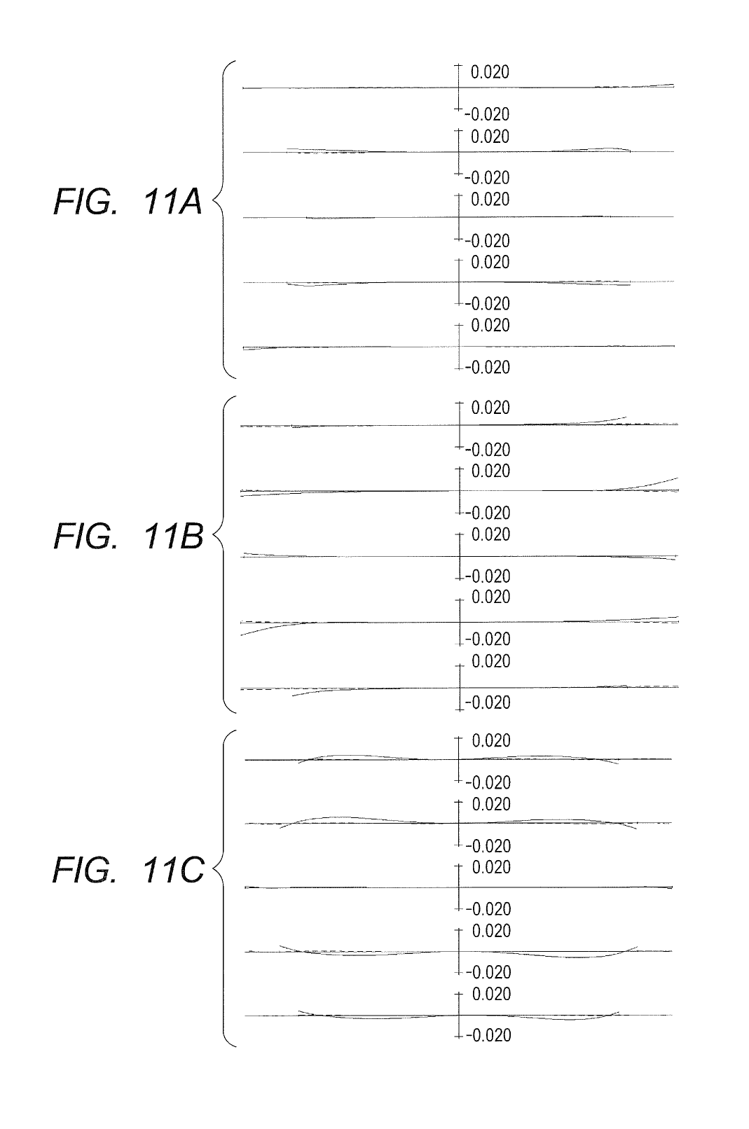

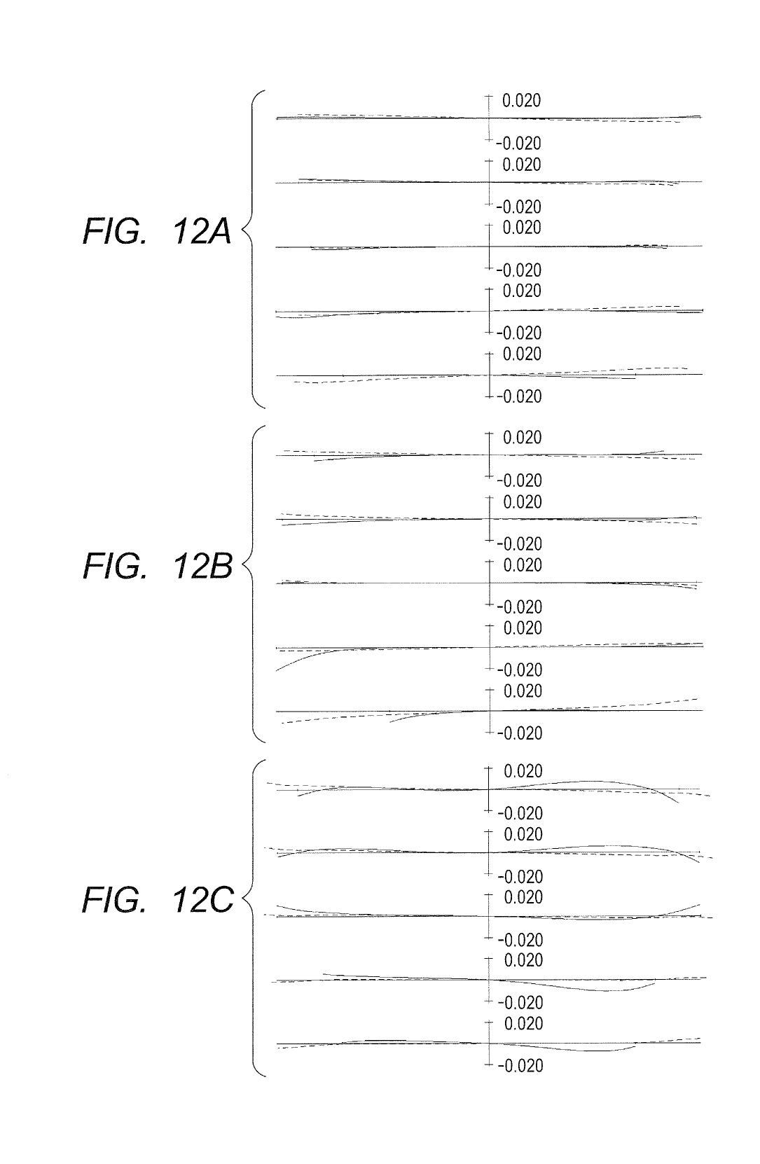

FIG. 9A, FIG. 9B, and FIG. 9C are respectively lens cross-sectional views at a wide angle end, at an intermediate zoom position, and at a telephoto end of Embodiment 3 of the present invention. FIG. 10A, FIG. 10B, and FIG. 10C are respectively longitudinal aberration diagrams at the wide angle end, at the intermediate zoom position, and at the telephoto end of Embodiment 3 of the present invention. FIG. 11A, FIG. 11B, and FIG. 11C are respectively lateral aberration diagrams at the wide angle end, at the intermediate zoom position, and at the telephoto end of Embodiment 3 of the present invention. FIG. 12A, FIG. 12B, and FIG. 12C are lateral aberration diagrams of Embodiment 3 of the present invention during the image blur correction at the wide angle end, the intermediate zoom position, and the telephoto end, respectively. Embodiment 3 is the zoom lens having a zoom ratio of approximately 61.52 and an aperture ratio (f-number) of from 3.51 to 6.82.

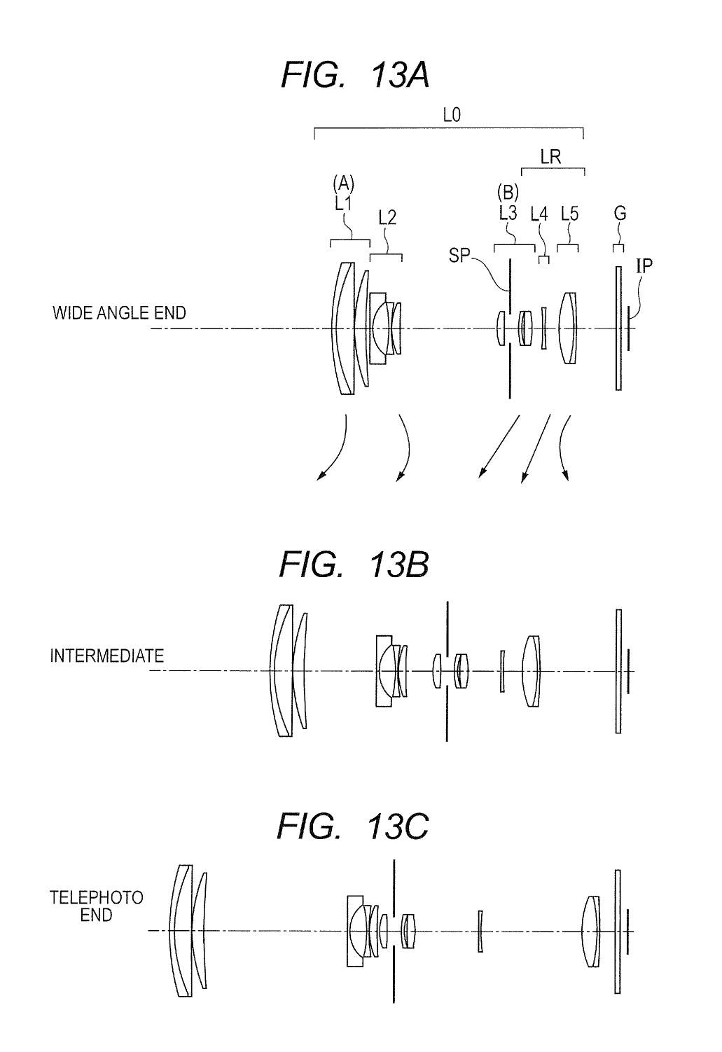

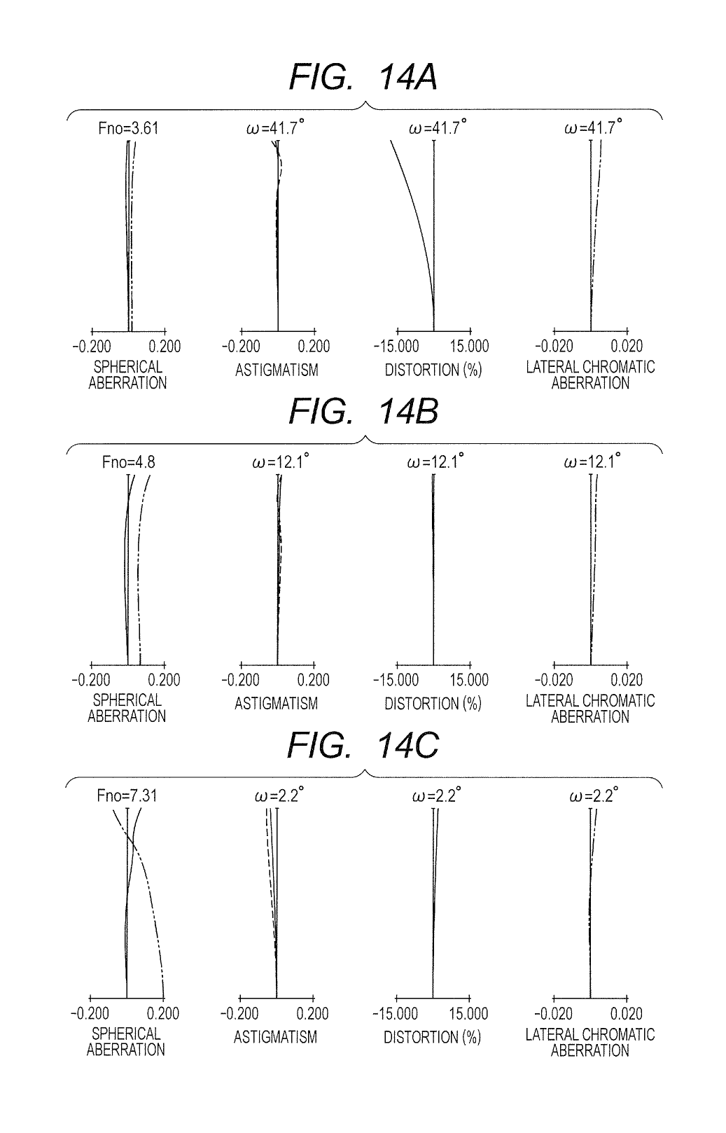

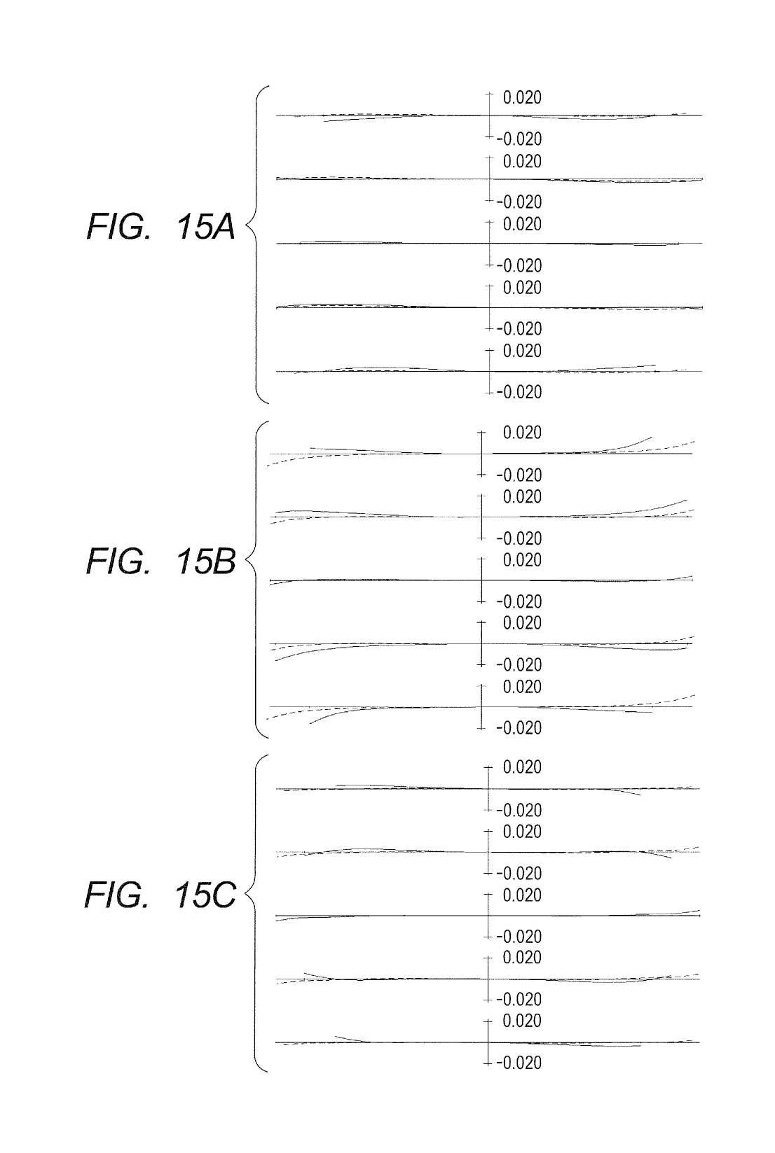

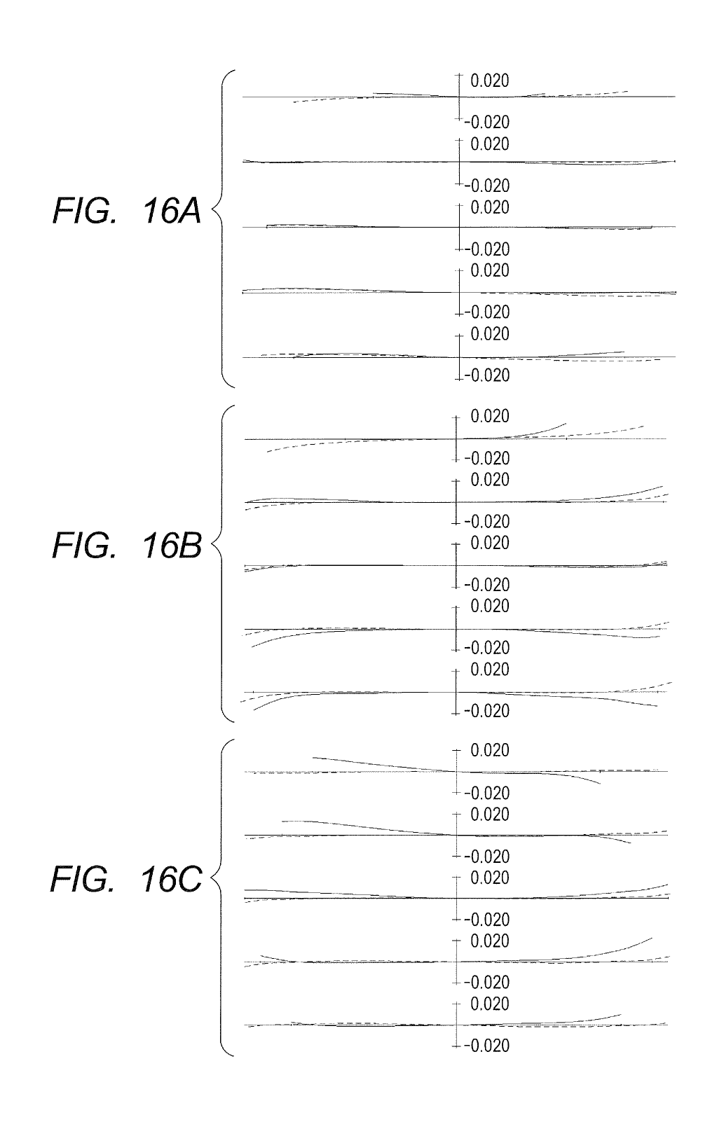

FIG. 13A, FIG. 13B, and FIG. 13C are respectively lens cross-sectional views at a wide angle end, at an intermediate zoom position, and at a telephoto end of Embodiment 4 of the present invention. FIG. 14A, FIG. 14B, and FIG. 14C are respectively longitudinal aberration diagrams at the wide angle end, at the intermediate zoom position, and at the telephoto end of Embodiment 4 of the present invention. FIG. 15A, FIG. 15B, and FIG. 15C are respectively lateral aberration diagrams at the wide angle end, at the intermediate zoom position, and at the telephoto end of Embodiment 4 of the present invention. FIG. 16A, FIG. 16B, and FIG. 16C are lateral aberration diagrams of Embodiment 4 of the present invention during the image blur correction at the wide angle end, the intermediate zoom position, and the telephoto end, respectively. Embodiment 4 is the zoom lens having a zoom ratio of approximately 21.59 and an aperture ratio (f-number) of from 3.61 to 7.31.

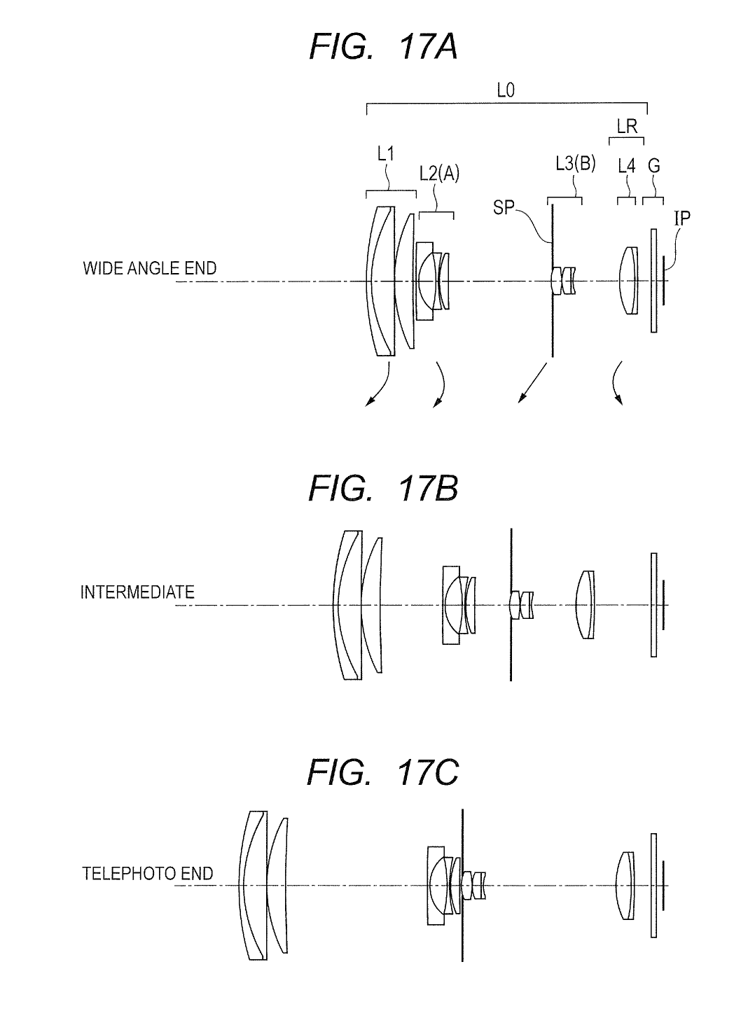

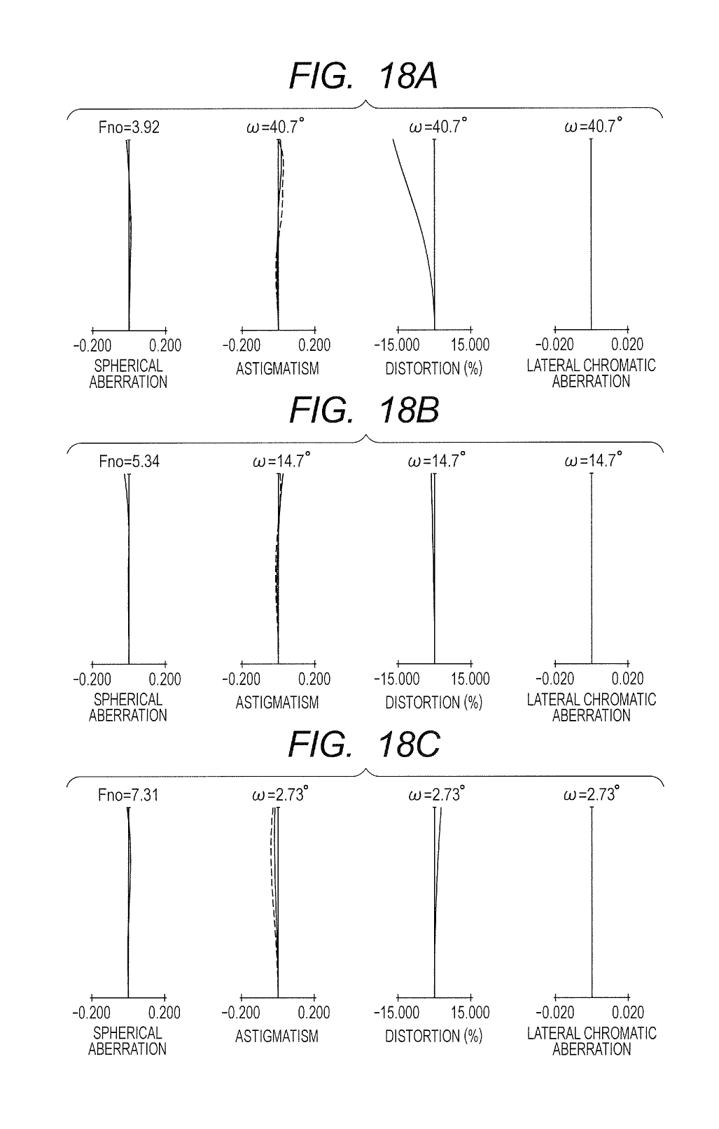

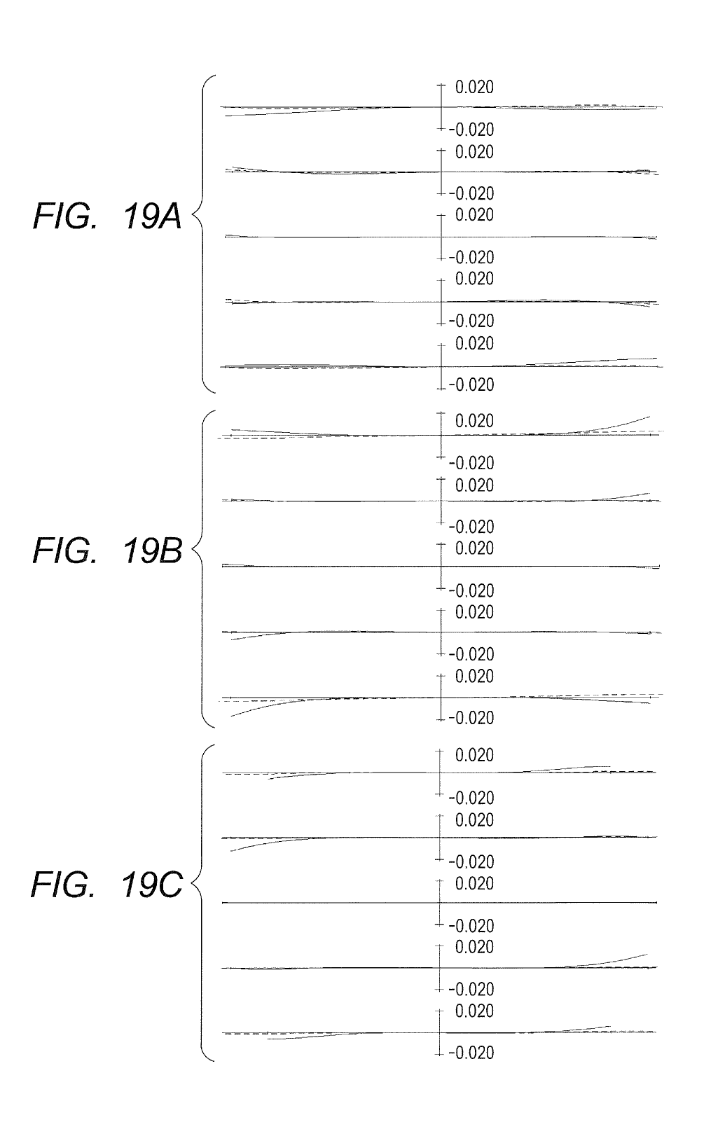

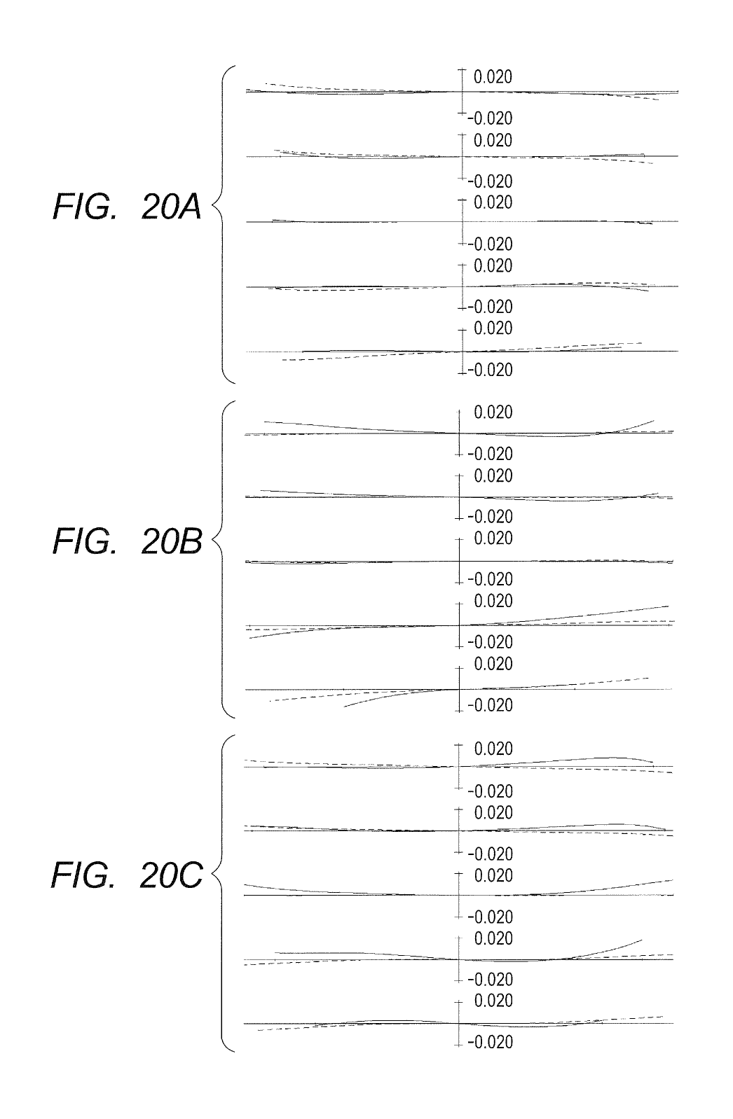

FIG. 17A, FIG. 17B, and FIG. 17C are respectively lens cross-sectional views at a wide angle end, at an intermediate zoom position, and at a telephoto end of Embodiment 5 of the present invention. FIG. 18A, FIG. 18B, and FIG. 18C are respectively longitudinal aberration diagrams at the wide angle end, at the intermediate zoom position, and at the telephoto end of Embodiment 5 of the present invention. FIG. 19A, FIG. 19B, and FIG. 19C are respectively lateral aberration diagrams at the wide angle end, at the intermediate zoom position, and at the telephoto end of Embodiment 5 of the present invention. FIG. 20A, FIG. 20B, and FIG. 20C are lateral aberration diagrams of Embodiment 5 of the present invention during the image blur correction at the wide angle end, the intermediate zoom position, and the telephoto end, respectively. Embodiment 5 is the zoom lens having a zoom ratio of approximately 17.04 and an aperture ratio (f-number) of from 3.92 to 7.31.

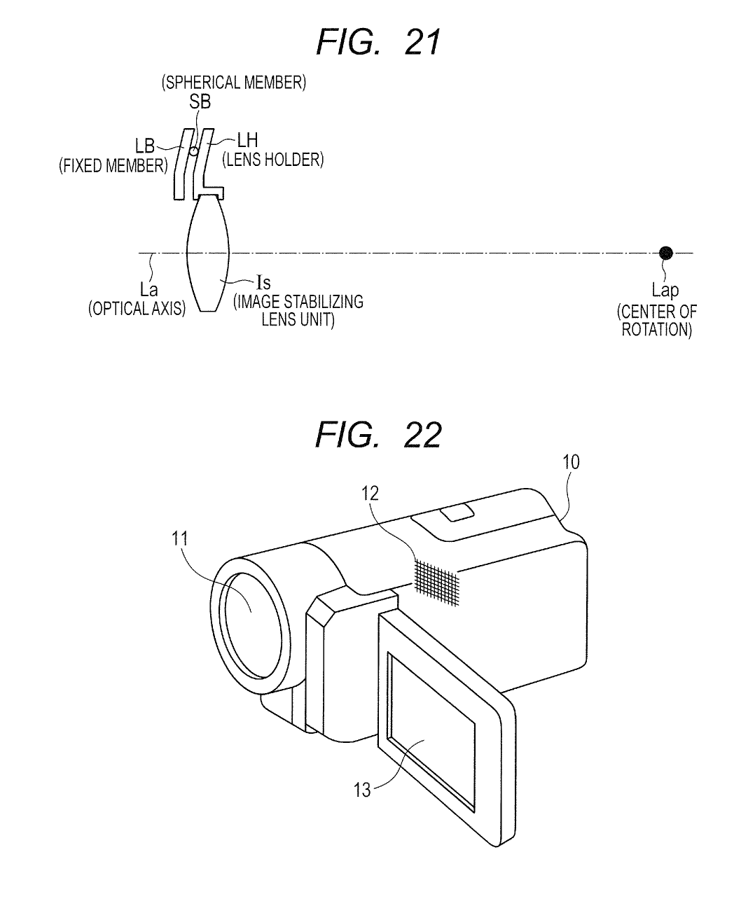

FIG. 21 is an explanatory view illustrating a rotation mechanism of the present invention. FIG. 22 is a schematic view illustrating a main part of an image pickup apparatus of the present invention.

The zoom lens of the present invention is used for an image pickup apparatus such as a digital camera, a video camera, or a silver halide film camera. In the lens cross-sectional views, the left side is a front side (object side or magnification side) while the right side is a rear side (image side or reduction side). In the lens cross-sectional views, symbol LO indicates a zoom lens, and symbol LR indicates a rear lens group including one or more lens units. Symbol i indicates an order of lens units from the object side to the image side, and symbol Li represents an i-th lens unit. An f-number determination member (hereinafter referred to also as “aperture stop”) SP has a function of aperture stop for determining (limiting) a minimum f-number (Fno) light flux.

An optical block G corresponds to an optical filter, a face plate, a quartz low-pass filter, an infrared cut filter, or the like. As an image plane IP, an imaging plane of an image pickup element (photo-electric conversion element) such as a CCD sensor or a CMOS sensor is arranged when the zoom lens is used as a photographing optical system for use in a video camera or a digital still camera. Alternatively, a photosensitive surface corresponding to a film surface is arranged when the zoom lens is used as a photographing optical system of a silver halide film camera.

Of the aberration diagrams, in the spherical aberration diagrams, the solid line indicates a d-line, and the two-dot chain line indicates a g-line. In the astigmatism diagrams, the dotted line indicates a meridional image plane, and the solid line indicates a sagittal image plane. The lateral chromatic aberration is shown by the g-line. The lateral aberration diagrams show, in order from an upper side, aberration diagrams of the d-line at image heights of 100%, 70%, the center, 70% on an opposite side, and 100% on the opposite side. The broken line indicates the sagittal image plane and the solid line indicates the meridional image plane. Symbol Fno represents an f-number and symbol co represents a half angle of view (degrees). The half angle of view co represents a value in terms of a ray tracing value. In the lens cross-sectional views, arrows indicate movement loci of the respective lens units from the wide angle end to the telephoto end during the zooming.

In Embodiments described below, the wide angle end and the telephoto end respectively mean the zoom positions when a variable power lens unit is located at ends in a range in which the variable power lens unit can be mechanically moved on the optical path. In each of Embodiments, two image stabilization units A and B, which are configured to move in a direction having a component in the direction perpendicular to the optical axis during the image blur correction, are included.

A lens configuration of a zoom lens according to each of Embodiments 1 to 4 is described. In lens cross-sectional views of FIG. 1A, FIG. 1B, FIG. 1C, FIG. 5A, FIG. 5B, FIG. 5C, FIG. 9A, FIG. 9B, FIG. 9C, FIG. 13A, FIG. 13B, and FIG. 13C, a first lens unit L1 having a positive refractive power, a second lens unit L2 having a negative refractive power, a third lens unit L3 having a positive refractive power, a fourth lens unit L4 having a negative refractive power, and a fifth lens unit L5 having a positive refractive power are illustrated. A rear lens group LR consists of the fourth lens unit L4 and the fifth lens unit L5. The arrows indicate moving loci of the lens units and an aperture stop SP during zooming from the wide angle end to the telephoto end.

An interval between each pair of adjacent lens units is changed during zooming so that, at the telephoto end as compared to the wide angle end, an interval between the first lens unit L1 and the second lens unit L2 is increased, an interval between the second lens unit L2 and the third lens unit L3 is decreased, and an interval between the third lens unit L3 and the rear lens group LR is changed. In the rear lens group LR, the lens units are configured to move so that an interval between the third lens unit L3 and the fourth lens unit L4 is increased, and an interval between the fourth lens unit L4 and the fifth lens unit L5 is increased.

At the telephoto end as compared to the wide angle end, the first lens unit L1, the third lens unit L3, and the fourth lens unit L4 are positioned on an object side. During zooming from the wide angle end to the telephoto end, the second lens unit L2 is configured to move along a locus that is convex toward an image side, and the fifth lens unit L5 is configured to move along a locus that is convex toward the object side. The lens units are configured to move appropriately during zooming to realize a high zoom ratio while downsizing an entire system of the zoom lens. Moreover, in FIG. 1A, FIG. 1B, FIG. 1C, FIG. 9A, FIG. 9B, and FIG. 9C, the aperture stop SP is arranged between the second lens unit L2 and the third lens unit L3, and is configured to move along a locus that is independent of those lens units during zooming.

More specifically, the aperture stop SP is configured to move so that, at the telephoto end as compared to the wide angle end, an interval between the second lens unit L2 and the aperture stop SP is reduced, and an interval between the aperture stop SP and the third lens unit L3 is reduced. In this manner, a distance from the aperture stop SP to the first lens unit L1 may be reduced at the wide angle end, and an effective diameter of a front lens, which is determined on a wide angle side, is reduced. Moreover, the interval between the second lens unit L2 and the third lens unit L3 may be reduced on a telephoto side, and as a result, movement amounts of the second lens unit L2 and the third lens unit L3 required for zooming are secured. In this manner, the high zoom ratio is realized while reducing a total length of the zoom lens.

In FIG. 5A, FIG. 5B, FIG. 5C, FIG. 13A, FIG. 13B, and FIG. 13C, the aperture stop SP is arranged in the third lens unit L3 (between lenses of the third lens unit L3). The aperture stop SP is arranged in the third lens unit L3 to reduce the interval between the second lens unit L2 and the third lens unit L3 at the telephoto end, with the result that sufficiently large movement amounts of the second lens unit L2 and the third lens unit L3 required for zooming may be secured. In this manner, it becomes easy to realize the high zoom ratio while reducing the total length of the zoom lens.

Note that, the aperture stop SP may be arranged on the image side of the third lens unit L3. In this case, it becomes difficult to reduce the effective diameter of the front lens, but it becomes easy to reduce diameters of the third lens unit L3 and the fourth lens unit L4 while securing large movement amounts of the second lens unit L2 and the third lens unit L3.

A lens configuration of a zoom lens according to Embodiment 5 is described. In the lens cross-sectional views of FIG. 17A, FIG. 17B, and FIG. 17C, a first lens unit L1 has a positive refractive power, a second lens unit L2 has a negative refractive power, a third lens unit L3 has a positive refractive power, and a fourth lens unit L4 has a positive refractive power. A rear lens group LR consists of the fourth lens unit L4. The lens units are configured to move so that, at the telephoto end as compared to the wide angle end during zooming, an interval between the first lens unit L1 and the second lens unit L2 is increased, an interval between the second lens unit L2 and the third lens unit L3 is reduced, and an interval between the third lens unit L3 and the fourth lens unit L4 is increased.

Further, at the telephoto end as compared to the wide angle end, the first lens unit L1 and the third lens unit L3 are positioned on the object side. Moreover, the second lens unit L2 is configured to move along a locus that is convex toward the image side, and the fourth lens unit L4 is configured to move along a locus that is convex toward the object side.

The lens units are configured to move appropriately as described above to realize both the downsizing and high magnification varying. The aperture stop SP is arranged on the object side of the third lens unit L3, and is configured to move integrally with the third lens unit L3 during zooming. The integral movement simplifies a movement mechanism for zooming. In each of Embodiments, focusing is performed by a lens unit arranged closest to the image side. During focusing from infinity to close distance, in each of Embodiments 1 to 4, the fifth lens unit L5 is configured to move toward the object side. During focusing from infinity to close distance, in Embodiment 5, the fourth lens unit L4 is configured to move toward the object side.

In order to correct blur on an image pickup plane, which is caused by camera shake or the like, that is, to perform image blur correction, the zoom lens in each of Embodiments includes two image stabilization units, which are configured to move so as to have a component in a direction perpendicular to the optical axis. One of the two image stabilization units is the image stabilization unit A, which is configured to move so as to have the component in the direction perpendicular to the optical axis.

In FIG. 1A, FIG. 1B, FIG. 1C, FIG. 5A, FIG. 5B, FIG. 5C, FIG. 9A, FIG. 9B, FIG. 9C, FIG. 17A, FIG. 17B, and FIG. 17C, the image stabilization unit A is the second lens unit L2. In FIG. 13A, FIG. 13B, and FIG. 13C, the image stabilization unit A is the first lens unit L1. The image blur correction is performed by moving the image stabilization unit A so as to have the component in the direction perpendicular to the optical axis.

For example, in FIG. 1A, FIG. 1B, FIG. 1C, FIG. 5A, FIG. 5B, and FIG. 5C, the second lens unit L2 is configured to move in the direction perpendicular to the optical axis to perform the image blur correction. Similarly, each of the second lens unit L2 in FIG. 9A, FIG. 9B, FIG. 9C, FIG. 17A, FIG. 17B, and FIG. 17C and the first lens unit L1 in FIG. 13A, FIG. 13B, and FIG. 13C is configured to be rotated around a point on or near the optical axis, the point being separated away from the lens units to a certain extent in an image side direction, to perform the image blur correction. FIG. 9A, FIG. 9B, FIG. 9C, FIG. 13A, FIG. 13B, FIG. 13C, FIG. 17A, FIG. 17B, and FIG. 17C are similar to FIG. 1A, FIG. 1B, FIG. 1C, FIG. 5A, FIG. 5B, and FIG. 5C in that the image stabilization unit A has a shift component in the direction perpendicular to the optical axis, and the function of image blur correction is obtained by the shift component. FIG. 9A, FIG. 9B, FIG. 9C, FIG. 13A, FIG. 13B, FIG. 13C, FIG. 17A, FIG. 17B, and FIG. 17C are different from FIG. 1A, FIG. 1B, FIG. 1C, FIG. 5A, FIG. 5B, and FIG. 5C in that the image stabilization unit A has a tilt component caused by the rotation.

Next, a structure in this case is described with reference to FIG. 21. In FIG. 21, a mechanism in which an image stabilization unit Is is rotated around one point Lap on an optical axis La is illustrated. The mechanism in the figure is realized by a structure in which several spherical members SB are sandwiched between a lens holder LH, which holds the image stabilization unit Is, and a fixed member LB adjacent to the lens holder LH. Therefore, a structure in which the lens holder LH is movable by rolling of the spherical members SB with respect to the fixed member LB is obtained.

In the above-mentioned structure, when receiving surfaces on which the spherical members SB are brought into contact with the fixed member LB and the lens holder LH have spherical shapes, the lens holder LH may rotate. Note that, the spherical surfaces serving as the receiving surfaces of the fixed member LB and the lens holder LH may have the same center of curvature.

In order to maintain good optical characteristics during the image blur correction, there is a need to correct decentering aberration generated when the image stabilization unit is moved in the direction having the component in the direction perpendicular to the optical axis. In FIG. 9A, FIG. 9B, FIG. 9C, FIG. 13A, FIG. 13B, FIG. 13C, FIG. 17A, FIG. 17B, and FIG. 17C, the tilt component of the image stabilization unit A is set so as to correct the decentering aberration generated by the shift component and hence to improve optical characteristics during the image blur correction. When a blur correction angle is increased in order to correct a large image blur, a shift amount of the image stabilization unit is also increased, with the result that the decentering aberration is increased. Also in the rotation in FIG. 9A, FIG. 9B, FIG. 9C, FIG. 13A, FIG. 13B, FIG. 13C, FIG. 17A, FIG. 17B, and FIG. 17C, when the shift amount is large, the decentering aberration is increased.

Therefore, in the zoom lens in each of Embodiments, a lens unit other than the image stabilization unit A is configured to move so as to have the component in the direction perpendicular to the optical axis to reduce the decentering aberration. The lens unit configured to move to reduce the decentering aberration generated by the image stabilization unit A is hereinafter referred to as the “image stabilization unit B”.

At this time, in FIG. 1A, FIG. 1B, FIG. 1C, FIG. 9A, FIG. 9B, FIG. 9C, FIG. 13A, FIG. 13B, FIG. 13C, FIG. 17A, FIG. 17B, and FIG. 17C, the image stabilization unit B is the third lens unit L3. In FIG. 5A, FIG. 5B, and FIG. 5C, the image stabilization unit B is the fourth lens unit L4. Each of the image stabilization units B is rotated around the point on or near the optical axis to intentionally generate the decentering aberration and hence to correct the decentering aberration generated by the image stabilization unit A. Further, a center of rotation is arranged near the image stabilization unit B so as not to generate a large shift component in the direction perpendicular to the optical axis.

When the large shift component is generated, a large space needs to be secured in advance in a lens barrel so as to allow the movement in the direction perpendicular to the optical axis. When the shift component is small, it becomes easy to arrange an actuator configured to move the image stabilization unit B, and hence to downsize the lens barrel.

In each of Embodiments, the image stabilization unit B is configured to move mainly to correct the decentering aberration. In each of Embodiments, the image stabilization unit B is also moved along with the movement of the image stabilization unit A to reduce the decentering aberration, and to obtain a good image during the image blur correction. In particular, even when an image blur correction angle is large, good optical characteristics are obtained with the action of the image stabilization unit B as compared to the structure with only the image stabilization unit A. Note that, aberrations reduced as the decentering aberration include decentering coma, a tilt of an image plane, decentering distortion, decentering astigmatism, decentering chromatic aberration, and the like.

Note that, as a rotation mechanism of the image stabilization unit B, the structure illustrated in FIG. 21 but with the receiving surfaces of the fixed member LB and the lens holder LH with respect to the spherical members SB having spherical shapes of a small radius of curvature may be used.

In each of Embodiments, it is preferred that the image stabilization unit A have a certain refractive power. An increase in refractive power may increase an image stabilization sensitivity and reduce a shift component amount for a predetermined image blur correction angle. As a result, the generation of the decentering aberration by the image stabilization unit A is reduced. Note that, the image stabilization sensitivity is a value obtained by dividing, when the image stabilization unit is moved (shifted) in the direction perpendicular to the optical axis, an amount by which an image point at an image plane center (image forming position) on the image plane is moved by the shift amount.

Moreover, it is preferred that the image stabilization unit A have a higher image stabilization sensitivity at the telephoto end than at the wide angle end. When a focal length of the entire system of the zoom lens at a predetermined zoom position is represented by f, a shift amount of the image stabilization unit A is represented by SA, an image stabilization sensitivity of the image stabilization unit A is represented by TA, and an image blur correction angle generated by the shift amount SA is represented by θA, the following expression is satisfied.

SA=f×tan θA/TA (A)

The shift amount SA is proportional to the focal length f, and hence as the focal length becomes longer, the shift amount SA tends to become larger. In contrast, the shift amount SA has an inverse proportional relationship with the image stabilization sensitivity TA. Therefore, it is preferred that the shift amount SA be set small in a structure in which the image stabilization sensitivity TA is set large at the telephoto end. With this structure, the generation of the decentering aberration by the shift amount SA of the image stabilization unit A may be reduced at the telephoto end. This structure is effective when it is desired to have a large image blur correction angle on the telephoto side in a zoom lens having a high zoom ratio, in particular. Next, the expression (A) leads to the following expression.

θA=tan⁻¹(SA×TA/f) (B)

When an image blur correction angle at a time when the image stabilization unit B is moved simultaneously with the movement of the image stabilization unit A is represented by θ, the expression (B) leads to the following expression.

θA/θ={tan⁻¹(SA×TA/f)}/θ (C)

The expression (C) expresses a ratio of the image blur correction angle θA resulting from the shift amount SA of the image stabilization unit A to the image blur correction angle θ at the time when the image stabilization unit A and the image stabilization unit B are simultaneously moved. When an image blur correction effect of the image stabilization unit B is not generated, θA=θ.

In each of Embodiments, the image stabilization unit B is prevented from generating a too much image stabilization action, and hence the value of the expression (C) is prevented from deviating significantly from 1. Note that, in a case where the expression (C) is larger than 1, the image blur correction by moving each of the image stabilization unit A and the image stabilization unit B has the opposite sign. Therefore, the image stabilization unit A needs to be moved by a larger amount to obtain a desired image blur correction angle. In a case where the expression (C) is smaller than 1, the image blur correction by moving each of the image stabilization unit A and the image stabilization unit B has the same sign.

Next, in each of Embodiments, it is preferred that the image stabilization unit A be a lens unit on the object side of the aperture stop SP because the effective diameter of the front lens is reduced. During the image blur correction, a height at which a light flux passes through the image stabilization unit A and lens units on the object side thereof is changed. Effective diameters of those lens units need to be set so that an amount of peripheral light during the image blur correction is secured. As the image blur correction angle becomes larger, the effective diameters become larger. When the image stabilization unit A is a lens unit that is on the object side of the aperture stop SP and as close to the object side as possible, the change in height at which the light flux passes during the image blur correction is reduced. As a result, the increase in effective diameter of the front lens is reduced while increasing the image blur correction angle.

Next, it is preferred that the image stabilization unit B have a certain refractive power. When the refractive power is increased, it becomes easy to correct the decentering aberration without increasing a rotation angle too much. When the rotation angle is too large, large higher-order decentering aberration is generated.

Moreover, when the image stabilization unit B is a lens unit on the image side of the image stabilization unit A, it becomes easy to downsize the image stabilization unit A. The image stabilization unit B has small need to have an image stabilization function, and hence does not need to be arranged on the object side as with the image stabilization unit A. When the image stabilization unit B is arranged near the aperture stop SP, a lens diameter is reduced, and hence an effect of downsizing a drive mechanism for the image stabilization unit B is obtained. It is more preferred that the zoom lens according to the present invention satisfy the conditions provided below.

A focal length of the image stabilization unit B is represented by fB, a focal length of the entire system at the telephoto end is represented by ft, a maximum value of the image blur correction angle at the telephoto end is represented by θt, and a rotation angle of the image stabilization unit B when the image blur correction at an image blur correction angle θt is performed at the telephoto end is represented by TBt. At this time, it is preferred to satisfy the following conditional expressions:

0.01<|fB|/ft<0.35 (1); and

0.85<|TBt|/θt<10.00 (2).

Next, technical meanings of the above-mentioned conditional expressions are described. The conditional expression (1) is an expression for defining the focal length, that is, a refractive power of the image stabilization unit B. When the ratio exceeds the upper limit to result in a long focal length and a too weak refractive power (too small absolute value of the refractive power) of the image stabilization unit B, generation of the decentering aberration during the rotation is reduced. As a result, when the rotation angle is set large to correct the decentering aberration generated by the image stabilization unit A, the large higher-order decentering aberration is generated. For example, large higher-order astigmatism and higher-order decentering distortion are generated.

Moreover, a large color shift in a decentering direction due to a prism action occurs. When the rotation angle is not set large, the decentering aberration generated by the image stabilization unit A is undercorrected. When the ratio falls below the lower limit of the conditional expression (1) to result in the short focal length and the too strong refractive power (too large absolute value of the refractive power) of the image stabilization unit B, the number of lenses forming the image stabilization unit B is increased. It is preferred that the decentering aberration generated when the image stabilization unit B is rotated be canceled by the aberrations generated by the image stabilization unit as lower-order aberrations to a certain extent.

When the refractive power of the image stabilization unit B is increased with a small number of constituent lenses, the aberrations are undercorrected as a lens unit, with the result that higher-order aberrations tend to be generated when decentered. When the aberrations of the image stabilization unit B are to be sufficiently corrected, there is a need to increase the number of constituent lenses, and hence the image stabilization unit B is disadvantageously increased in size.

The conditional expression (2) defines the rotation angle of the image stabilization unit B. When the ratio exceeds the upper limit of the conditional expression (2) to result in a too large rotation angle with respect to the image blur correction angle, the large higher-order decentering aberration is generated. For example, the large higher-order astigmatism and higher-order decentering distortion are generated. Moreover, the large color shift in the decentering direction due to the prism action occurs. For the purpose of reducing relatively lower-order decentering aberration generated by the image stabilization unit A, it is desired that the ratio do not exceed the upper limit value.

When the ratio falls below the lower limit of the conditional expression (2) to result in a too small rotation angle with respect to the image blur correction angle, a positional accuracy at a time of being driven becomes disadvantageously high. The image stabilization unit B needs to be driven in close synchronization with the image stabilization unit A so that a correction residue of the decentering aberration falls within an allowable range. When the ratio falls below the lower limit, the correction residue of the decentering aberration exceeds the allowable range, and hence it becomes difficult to obtain the good optical characteristics. It is more preferred to set the numerical value ranges of the conditional expressions (1) and (2) as follows.

0.03<|fB|/ft<0.30 (1a)

0.95<|TBt|/θt<9.00 (2a)

As described above, according to the present invention, the zoom lens including the small image stabilization unit and having high optical characteristics even when the image blur correction angle is large can be obtained.

In each of Embodiments, it is further preferred to satisfy at least one of the conditional expressions provided below. A focal length of the image stabilization unit A is represented by fA. A distance (on the optical axis) from a vertex of a lens surface closest to the object side of the image stabilization unit B to the center of rotation of the image stabilization unit B at the telephoto end is represented by RBt, and a distance (on the optical axis) from the vertex of the lens surface closest to the object side to a vertex of a lens surface closest to the image side of the image stabilization unit B is represented by LB. A shift component in the direction perpendicular to the optical axis of the image stabilization unit A when the image blur correction at the image blur correction angle θt is performed at the telephoto end is represented by SAt, and an image stabilization sensitivity of the image stabilization unit A at the telephoto end is represented by TAt.

A maximum value of the image blur correction angle at the wide angle end is represented by θw, a shift component in the direction perpendicular to the optical axis of the image stabilization unit A when the image blur correction at the image blur correction angle θw is performed is represented by SAw, an image stabilization sensitivity of the image stabilization unit A at the wide angle end is represented by TAw, and a focal length of the entire system at the wide angle end is represented by fw. A focal length of the first lens unit L1 is represented by f1. The first lens unit L1 includes positive lenses and negative lenses, and an Abbe number and a partial dispersion ratio of a material of a positive lens G1p having the highest Abbe number of materials of the positive lenses included in the first lens unit L1 are represented by ν1p and PgF1p, respectively. Moreover, an Abbe number and a partial dispersion ratio of a material of a negative lens G1n having the lowest Abbe number of materials of the negative lenses included in the first lens unit L1 are represented by ν1n and PgF1n, respectively.

A zoom lens LO includes an aperture stop SP, and a distance from the aperture stop SP to a vertex of a lens surface closest to the image side of the image stabilization unit A at the wide angle end is represented by DSAw. A distance from the vertex of the lens surface closest to the image side of the image stabilization unit A to the vertex of the lens surface closest to the object side of the image stabilization unit B at the wide angle end is represented by DABw. It is preferred to satisfy at least one of the following conditional expressions.

0.01<|fA|/ft<0.45 (3)

−1.00<RBt/LB<1.00 (4)

0.7<{tan⁻¹(SAt×TAt/ft)}/θt<1.4 (5)

0.7<{tan⁻¹(SAw×TAw/fw)}/θw<1.4 (6)

3.00<TAt/TAw (7)

0.20<f1/ft<0.50 (8)

−0.002<(PgF1p−PgF1n)/(ν1p−ν1n) (9)

−20.00<DSAw/fw<−2.00 (10)

2.00<DABw/fw<20.00 (11)

Note that, a sign of the distance RBt is positive when the center of rotation is on the image side of the vertex of the lens surface closest to the object side of the image stabilization unit B. A sign of the distance DSAw is positive when the vertex of the lens surface closest to the image side of the image stabilization unit A is on the image side of the aperture stop SP. A sign of the distance DABw is positive when the vertex of the lens surface closest to the object side of the image stabilization unit B is on the image side of the vertex of the lens surface closest to the image side of the image stabilization unit A.

Next, technical meanings of the above-mentioned conditional expressions are described. The conditional expression (3) is an expression that defines the focal length, that is, a refractive power of the image stabilization unit A. When the ratio exceeds the upper limit value, and the focal length becomes too long, that is, an absolute value of the refractive power becomes too small, the effect of the image blur correction by the shift component is reduced. As a result, when the shift component is increased to obtain the desired image blur correction angle, a drive mechanism is increased in size.

When the ratio falls below the lower limit value, and the focal length becomes too short, that is, the absolute value of the refractive power becomes too large, a positional accuracy at a time of being driven becomes high. The image stabilization unit A needs to be controlled so that an image blur correction residue falls within an allowable range. Therefore, when the ratio falls below the lower limit, the blur correction residue exceeds the allowable range, and hence stable image blur correction becomes difficult.

The conditional expression (4) defines a position of the center of rotation of the image stabilization unit B. When the center of rotation is located away from the image stabilization unit B, a radius of rotation becomes large, and hence the shift component is generated with the rotation. When the ratio exceeds the upper limit or falls below the lower limit, the radius of rotation becomes too large, and the large shift component is generated with the rotation, with the result that the drive mechanism for the image stabilization unit B is increased in size.

The conditional expression (5) defines a ratio of the image blur correction angle caused only by the shift component of the image stabilization unit A to the image blur correction angle of the entire system at the telephoto end. When the ratio of the image blur correction angle of the image stabilization unit A is too large and exceeds the upper limit value, the shift component of the image stabilization unit A required to obtain the desired image blur correction angle becomes large. In this case, the drive mechanism for the image stabilization unit A is increased in size. When a movement amount of the image stabilization unit A is too large, lens diameters of the image stabilization unit A or lens units on the object side thereof are increased to secure the amount of peripheral light at the telephoto end, and the entire system is increased in size.

On the other hand, when the ratio falls below the lower limit, the image blur correction angle of the image stabilization unit B needs to be increased to compensate for the reduced image blur correction angle of the image stabilization unit A. In this case, the shift component of the image stabilization unit B becomes too large, and the drive mechanism for the image stabilization unit B is increased in size.

The conditional expression (6) defines a ratio of the image blur correction angle caused only by the shift component of the image stabilization unit A to the image blur correction angle of the entire system at the wide angle end. When the ratio of the image blur correction angle of the image stabilization unit A is too large and exceeds the upper limit value, the shift component of the image stabilization unit A required to obtain the desired image blur correction angle becomes large. In this case, the drive mechanism for the image stabilization unit A is increased in size. When a movement amount of the image stabilization unit A is too large, lens diameters of the image stabilization unit A or lens units on the object side thereof is increased to secure the amount of peripheral light at the wide angle end, and the entire system is increased in size.

On the other hand, when the ratio falls below the lower limit, the image blur correction angle of the image stabilization unit B needs to be increased to compensate for the reduced image blur correction angle of the image stabilization unit A. In this case, the shift component of the image stabilization unit B becomes too large, and the drive mechanism for the image stabilization unit B is increased in size.

The conditional expression (7) defines a ratio of the image stabilization sensitivity at the telephoto end to the image stabilization sensitivity at the wide angle end of the image stabilization unit A.

When the ratio of the image stabilization sensitivities becomes too small and falls below the lower limit, the image stabilization sensitivity at the telephoto end is too low, and the shift component of the image stabilization unit A is increased. Therefore, the drive mechanism for the image stabilization unit A is increased in size. Moreover, the increased shift component generates the large decentering aberration, and it becomes difficult to correct the decentering aberration even with the rotation of the image stabilization unit B. Therefore, it becomes difficult to obtain the good optical characteristics during the image stabilization.

The conditional expression (8) defines the focal length, that is, the positive refractive power of the first lens unit. When the ratio exceeds the upper limit, and the focal length is too long, that is, the positive refractive power is too weak, the total length of the zoom lens at the telephoto end is increased, and it becomes difficult to downsize the entire system. When the ratio falls below the lower limit, and hence the focal length is too short, that is, the positive refractive power is too strong, large spherical aberration is generated at the telephoto end. At this time, when the number of lenses of the first lens unit L1 is increased in order to reduce the spherical aberration, the first lens unit L1 is increased in size, the effective diameter of the front lens is increased, and a weight of the zoom lens is increased.

The conditional expression (9) defines a relationship between the partial dispersion ratios of the materials of the positive lenses and the materials of the negative lenses forming the first lens unit L1. In order to reduce a second-order spectrum at the telephoto end, it is preferred that the partial dispersion ratios of the materials of the positive lenses be relatively large, and that the partial dispersion ratios of the materials of the negative lenses be relatively small. Further, in order to realize first-order achromatization and the reduction in second-order spectrum without increasing the refractive powers of the negative lenses, it is preferred that the expression (9) be close to zero. When the expression falls below the lower limit value and deviates away from zero, the second-order spectrum is increased, and a sense of resolution is reduced due to color bleeding.

The conditional expression (10) defines a position of the image stabilization unit A with respect to the aperture stop SP. It is preferred that the image stabilization unit A be arranged on the object side of the aperture stop SP in terms of reducing the effective diameter of the front lens. When the ratio exceeds the upper limit, and the image stabilization unit A is too close to the aperture stop SP, the effective diameter of the front lens is increased in order to secure the amount of peripheral light during the image stabilization, and hence it becomes difficult to downsize the entire system.

When the ratio falls below the lower limit, and hence the image stabilization unit A is separated too far from the aperture stop SP, a position at which an off-axial light flux is bent in the image stabilization unit A becomes high. As a result, large variations in aberrations, for example, decentering astigmatism and image tilt are generated in the off-axial light flux during the image stabilization. At the wide angle end, in particular, an angle at which the off-axial light flux enters the image stabilization unit A tends to be steep, and hence those large variations in decentering aberrations are generated.

The conditional expression (11) defines a position of the image stabilization unit B with respect to the image stabilization unit A. In order to downsize the drive mechanism, it is preferred that the image stabilization unit B be arranged near the aperture stop SP. As a result, the image stabilization unit B is arranged to a certain extent on the image side of the image stabilization unit A. However, when the ratio exceeds the upper limit, and hence the image stabilization unit B is separated too far from the image stabilization unit A, that is, brought close to the image plane, the decentering astigmatism tends to be generated in the image stabilization unit B, in particular, and it becomes difficult to correct the image tilt and the decentering chromatic aberration.

When the ratio falls below the lower limit, and hence the image stabilization unit B is too close to the image stabilization unit A, the lens diameter of the image stabilization unit B is increased, and hence it becomes difficult to downsize the entire system. At the wide angle end, in particular, an effective lens diameter tends to be disadvantageously increased at a position close to the front lens. It is further preferred to set the numerical value ranges of the conditional expressions (3) to (11) as follows.

0.02<|fA|/ft<0.40 (3a)

−0.80<RBt/LB<0.80 (4a)

0.8<{tan⁻¹(SAt×TAt/ft)}/θt<1.3 (5a)

0.75<{tan⁻¹(SAw×TAw/fw)}/θw<1.35 (6a)

4.00<TAt/TAw (7a)

0.25<f1/ft<0.46 (8a)

−0.0018<(PgF1p−PgF1n)/(ν1p−ν1n) (9a)

−15.00<DSAw/fw<−2.50 (10a)

2.50<DABw/fw<16.00 (11a)

Note that, in each of Embodiments 1 and 3, the rear lens group LR consists, in order from the object side to the image side, of a fourth lens unit L4 having a negative refractive power, and a fifth lens unit L5 having a positive refractive power, and each of the fourth lens unit L4 and the fifth lens unit L5 is configured to move along a locus that is different from those of the other lens units during zooming. The image stabilization unit A is the second lens unit L2, and the image stabilization unit B is the third lens unit L3.

In Embodiment 2, the rear lens group LR consists, in order from the object side to the image side, of a fourth lens unit L4 having a negative refractive power, and a fifth lens unit L5 having a positive refractive power, and each of the fourth lens unit L4 and the fifth lens unit L5 is configured to move along a locus that is different from those of the other lens units during zooming. The image stabilization unit A is the second lens unit L2, and the image stabilization unit B is the fourth lens unit L4.

In Embodiment 4, the rear lens group LR consists, in order from the object side to the image side, of a fourth lens unit L4 having a negative refractive power, and a fifth lens unit L5 having a positive refractive power, and each of the fourth lens unit L4 and the fifth lens unit L5 is configured to move along a locus that is different from those of the other lens units during zooming. The image stabilization unit A is the first lens unit L1, and the image stabilization unit B is the third lens unit L3.

In Embodiment 5, the rear lens group LR consists of a fourth lens unit L4 having a positive refractive power, and the fourth lens unit L4 is configured to move along a locus that is convex toward the object side during zooming from the wide angle end to the telephoto end. The image stabilization unit A is the second lens unit L2, and the image stabilization unit B is the third lens unit L3.

Next, a camcorder (video camera) according to one embodiment of the present invention, which uses the zoom lens of the present invention as a photographing optical system, is described with reference to FIG. 22. In FIG. 22, the camcorder includes a camera main body 10 and a photographing optical system 11 corresponding to any one of the zoom lenses described above in Embodiments 1 to 5. A solid-state image pickup element (photo-electric conversion element) 12 such as a CCD sensor or a CMOS sensor is built in the camera main body 10, and receives light corresponding to an object image formed by the photographing optical system 11. A finder 13 includes a liquid crystal display panel or the like, and is used to observe the object image formed on the solid-state image pickup element 12.

It is preferred that the image pickup apparatus of the present invention include any one of the above-mentioned zoom lenses and a circuit for electrically correcting the distortion and/or the lateral chromatic aberration. If the zoom lens is constructed to have a lens structure which can permit the distortion in such a manner, it becomes easy to reduce the number of lenses of the zoom lens and the size of the zoom lens. In addition, by electrically correcting the lateral chromatic aberration, the color bleeding of the photographed image is reduced and the resolving power is easily enhanced.

Next, each of Numerical data, which correspond to Embodiments of the present invention, respectively, is described. In each of Numerical data, Symbol i indicates an order of surfaces from the object side. In the Numerical data, symbol ri represents a radius of curvature of an i-th lens surface in order from the object side. Symbol di represents a lens thickness and an air gap between an i-th surface and an (i+1)th surface in order from the object side. Symbols ndi and νdi represent a refractive index and an Abbe number with respect to the d-line of glass of a material between the i-th surface and the (i+1)th surface in order from the object side, respectively.

In Embodiment 5, the value of the interval d12 is negative because the aperture stop SP and the third lens unit L3 are counted in the stated order from the object side to the image side. An aspherical shape is expressed by the expression below.

$$X = \frac{( 1 / R ) {H}^{2}}{1 + \sqrt{1 - ( 1 + K ) {( H / R )}^{2}}} + A 4 \times H 4 + A 6 \times H 6 + A 8 \times H 8 + A 10 \times H 10$$

where the X axis corresponds to the optical axis direction, the H axis corresponds to the direction perpendicular to the optical axis, the light propagation direction is positive, symbol R represents a paraxial curvature radius, symbol K represents a conic constant, and symbols A4, A6, A8, and A10 represent aspherical coefficients, respectively.

In addition, [e+x] means ×10^{+x} and [e−x] means ×10^{-x}. Symbol BF is back focus, which is represented by an air-converted length from a final lens surface to a paraxial image plane.

A total lens length is obtained by adding the length corresponding to the back focus BF to a distance from a forefront lens surface to the final lens surface. An aspherical surface is represented by adding the mark “*” after a surface number. In the lens unit position data during the image blur correction, the image blur correction angle θ indicates the maximum blur correction angle when the image stabilization unit A and the image stabilization unit B are configured to move simultaneously. More specifically, the image blur correction angle θ refers to an angle formed by a principal ray of a light flux that forms an image at a point of intersection with the optical axis on the image plane with the optical axis on the object side of the first lens unit L1. The positive sign means a case where, in the lens cross-sectional views in Embodiments, the principal ray is located above the optical axis on the object side of the first lens unit L1. Relationships between the above-mentioned conditional expressions and various numerical values in the numerical value data are shown in Table 1.

The shift amount SA of the image stabilization unit A indicates a movement amount in a case where the image stabilization unit A is configured to move only by being shifted. The positive sign means upward movement in the lens cross-sectional views in Embodiments. In a case where the image stabilization unit A is configured to be rotated, a position thereof is expressed by a center-of-rotation position and a rotation angle. The center-of-rotation position indicates a distance from the vertex of the lens surface closest to the object side of the image stabilization unit A. The positive sign means that the center of rotation is located on the image side of the vertex of the lens surface closest to the object side of the image stabilization unit A. The positive sign of the rotation angle of the image stabilization unit A means a counter-clockwise direction in the lens cross-sectional views in Embodiments.

The shift component SA of the image stabilization unit A indicates a distance from the vertex of the lens surface closest to the object side of the image stabilization unit A to the optical axis in the state of being determined by the center of rotation and the rotation angle. The positive sign means upward movement in the lens cross-sectional views in Embodiments.

A center-of-rotation position RB of the image stabilization unit B represents a center-of-rotation position with reference to the vertex of the lens surface closest to the object side of the image stabilization unit B. The positive sign means that the center of rotation is located on the image side of the vertex of the lens surface closest to the object side of the image stabilization unit B. The positive sign of the rotation angle TB of the image stabilization unit B means the counter-clockwise direction in the lens cross-sectional views in Embodiments. Note that, the above-mentioned positional data of the image stabilization unit A and the image stabilization unit B corresponds to the image blur correction angle θ.

### Embodiment 1

Unit mm
Surface data

| Surface number | | | | |
|---|---|---|---|---|
| i | ri | di | ndi | νdi |
| 1 | 90.506 | 1.45 | 1.91082 | 35.3 |
| 2 | 49.691 | 5.25 | 1.49700 | 81.5 |
| 3 | −190.810 | 0.05 | | |
| 4 | 41.122 | 3.30 | 1.49700 | 81.5 |
| 5 | 123.186 | (Variable) | | |
| 6 | 176.629 | 0.75 | 1.83481 | 42.7 |
| 7 | 8.495 | 5.17 | | |
| 8 | −31.845 | 0.60 | 1.77250 | 49.6 |
| 9 | 31.806 | 0.16 | | |
| 10 | 17.211 | 1.95 | 1.95906 | 17.5 |
| 11 | 58.494 | (Variable) | | |
| 12 (Stop) | ∞ | (Variable) | | |
| 13* | 10.127 | 2.70 | 1.55332 | 71.7 |
| 14* | −164.352 | 2.05 | | |
| 15 | 28.069 | 0.60 | 1.80400 | 46.6 |
| 16 | 10.483 | 0.35 | | |
| 17 | 15.141 | 0.60 | 2.00100 | 29.1 |
| 18 | 10.941 | 2.40 | 1.49700 | 81.5 |
| 19 | −25.985 | (Variable) | | |
| 20 | 117.589 | 0.70 | 1.48749 | 70.2 |
| 21 | 25.315 | (Variable) | | |
| 22 | 25.258 | 2.20 | 1.88300 | 40.8 |
| 23 | −24.535 | 0.50 | 2.00069 | 25.5 |
| 24 | −3,781.915 | (Variable) | | |
| 25 | ∞ | 0.80 | 1.51633 | 64.1 |
| 26 | ∞ | 0.97 | | |
| Image surface | ∞ | | | |

Aspherical surface data

Thirteenth surface
K = −2.78122e−001 A4 = −5.12569e−005 A6 = −2.68879e−007
A8 = −4.43947e−010
Fourteenth surface
K = −5.90735e−002 A4 = 2.88676e−005 A6 = −2.74728e−007
A8 = −5.60426e−011

Various data
Zoom ratio 47.49

| | Wide angle | Intermediate | Telephoto |
|---|---|---|---|
| Focal length | 4.42 | 25.16 | 209.90 |
| F-number | 3.50 | 5.23 | 6.72 |
| Half angle of | 41.96 | 8.72 | 1.05 |
| view (degree) | | | |
| Image height | 3.33 | 3.88 | 3.88 |
| Total lens length | 96.70 | 108.91 | 138.21 |
| BF | 11.40 | 24.43 | 9.97 |
| d5 | 0.75 | 30.51 | 61.69 |
| d11 | 36.18 | 10.05 | 1.05 |
| d12 | 9.92 | 1.87 | 0.35 |
| d19 | 2.85 | 6.81 | 8.69 |
| d21 | 4.83 | 4.47 | 25.68 |
| d24 | 9.90 | 22.93 | 8.48 |

Zoom lens unit data

| Unit | First surface | Focal length |
|---|---|---|
| 1 | 1 | 80.32 |
| 2 | 6 | −9.38 |
| 3 | 12 | ∞ |
| 4 | 13 | 19.68 |
| 5 | 20 | −66.34 |
| 6 | 22 | 32.67 |
| 7 | 25 | ∞ |

| | |
|---|---|
| PgF1p | 0.5374 |
| PgF1n | 0.5824 |
| Image stabilization unit A | Second lens unit L2 |
| Image stabilization unit B | Third lens unit L3 |

Data at time of image blur correction

| | Wide angle | | Intermediate | | Telephoto | |
|---|---|---|---|---|---|---|
| Image blur correction | 3.999 | degrees | 1.498 | degrees | 0.390 | degree |
| angle θ | | | | | | |
| Shift amount SA of | −0.582 | mm | −0.439 | mm | −0.479 | mm |
| image stabilization | | | | | | |
| unit A | | | | | | |
| Image stabilization | −0.4380 | | −1.4994 | | −3.8224 | |
| sensitivity TA of | | | | | | |
| image stabilization | | | | | | |
| unit A | | | | | | |
| Center-of-rotation | −5.000 | mm | −5.000 | mm | −5.000 | mm |
| position RB of image | | | | | | |
| stabilization unit B | | | | | | |
| Rotation angle TB of | 0.500 | degree | 0.000 | degree | −1.667 | degrees |
| image stabilization | | | | | | |
| unit B | | | | | | |

### Embodiment 2

Unit mm
Surface data

| Surface number | | | | |
|---|---|---|---|---|
| i | ri | di | ndi | νdi |
| 1 | 41.449 | 0.90 | 1.85478 | 24.8 |
| 2 | 27.348 | 3.48 | 1.49700 | 81.5 |
| 3 | −1,153.447 | 0.05 | | |
| 4 | 27.520 | 2.10 | 1.60311 | 60.6 |
| 5 | 92.432 | (Variable) | | |
| 6 | 282.227 | 0.45 | 1.83481 | 42.7 |
| 7 | 6.352 | 3.65 | | |
| 8 | −21.432 | 0.35 | 1.83481 | 42.7 |
| 9 | 21.296 | 0.05 | | |
| 10 | 13.265 | 1.70 | 1.95906 | 17.5 |
| 11 | 111.345 | (Variable) | | |
| 12* | 7.038 | 2.10 | 1.49710 | 81.6 |
| 13* | 298.824 | 1.34 | | |
| 14 (Stop) | ∞ | 0.76 | | |
| 15 | 7.765 | 0.40 | 1.85478 | 24.8 |
| 16 | 5.114 | 0.42 | | |
| 17* | 7.160 | 2.20 | 1.49710 | 81.6 |
| 18* | −79.748 | (Variable) | | |
| 19 | −26.607 | 0.40 | 1.77250 | 49.6 |
| 20 | 6.539 | 1.35 | 1.69895 | 30.1 |
| 21 | 28.760 | (Variable) | | |
| 22 | 20.818 | 2.90 | 1.83481 | 42.7 |
| 23 | −14.775 | 0.40 | 1.92286 | 18.9 |
| 24 | −38.951 | (Variable) | | |
| 25 | ∞ | 0.80 | 1.51633 | 64.1 |
| 26 | ∞ | 1.30 | | |
| Image surface | ∞ | | | |

Aspherical surface data

Twelfth surface
K = 7.35330e−001 A4 = −4.31802e−004 A6 = −1.58020e−005
A8 = −7.68839e−007 A10 = −1.07274e−008
Thirteenth surface
K = 3.82706e−005 A4 = 1.63912e−004 A6 = −2.48920e−005
A8 = −3.66782e−008
Seventeenth surface
K = −1.19620e+000 A4 = 1.01141e−003 A6 = −2.75883e−005
A8 = −8.58844e−008
Eighteenth surface
K = 1.61705e−004 A4 = 5.28935e−004 A6 = −2.64531e−005
A8 = −8.07045e−007

Various data
Zoom ratio 28.93

| | Wide angle | Intermediate | Telephoto |
|---|---|---|---|
| Focal length | 4.58 | 23.87 | 132.52 |
| F-number | 3.32 | 5.18 | 6.86 |
| Half angle of | 40.86 | 9.23 | 1.66 |
| view (degree) | | | |
| Image height | 3.33 | 3.88 | 3.88 |
| Total lens length | 64.66 | 73.44 | 85.95 |
| BF | 9.08 | 20.63 | 5.97 |
| d5 | 0.54 | 15.72 | 29.29 |
| d11 | 25.87 | 6.64 | 0.40 |
| d18 | 1.75 | 2.83 | 6.48 |
| d21 | 2.41 | 2.62 | 18.81 |
| d24 | 7.25 | 18.81 | 4.14 |

Zoom lens unit data

| Unit | First surface | Focal length |
|---|---|---|
| 1 | 1 | 42.92 |
| 2 | 6 | −6.71 |
| 3 | 12 | 11.84 |
| 4 | 19 | −15.24 |
| 5 | 22 | 17.69 |
| 6 | 25 | ∞ |

| | |
|---|---|
| PgF1p | 0.5374 |
| PgF1n | 0.6121 |
| Image stabilization unit A | Second lens unit L2 |
| Image stabilization unit B | Fourth lens unit L4 |

Data at time of image blur correction

| | Wide angle | | Intermediate | | Telephoto | |
|---|---|---|---|---|---|---|
| Image blur correction | 3.977 | degrees | 1.505 | degrees | 0.992 | degree |
| angle θ | | | | | | |
| Shift amount SA of | −0.518 | mm | −0.318 | mm | −0.494 | mm |
| image stabilization | | | | | | |
| unit A | | | | | | |
| Image stabilization | −0.6188 | | −1.9671 | | −4.6801 | |
| sensitivity TA of | | | | | | |
| image stabilization | | | | | | |
| unit A | | | | | | |
| Center-of-rotation | 0.420 | mm | 0.420 | mm | 0.420 | mm |
| position RB of image | | | | | | |
| stabilization unit B | | | | | | |
| Rotation angle TB of | −0.500 | degree | −0.500 | degree | −2.000 | degrees |
| image stabilization | | | | | | |
| unit B | | | | | | |

### Embodiment 3

Unit mm
Surface data

| Surface number | | | | |
|---|---|---|---|---|
| i | ri | di | ndi | νdi |
| 1 | 92.972 | 1.48 | 1.91082 | 35.3 |
| 2 | 51.921 | 5.43 | 1.49700 | 81.5 |
| 3 | −345.037 | 0.05 | | |
| 4 | 47.064 | 4.00 | 1.49700 | 81.5 |
| 5 | 216.541 | (Variable) | | |
| 6 | 194.017 | 0.69 | 1.83481 | 42.7 |
| 7 | 8.114 | 3.89 | | |
| 8 | −76.733 | 0.55 | 1.80400 | 46.6 |
| 9 | 75.097 | 1.44 | | |
| 10 | −23.437 | 0.55 | 1.83481 | 42.7 |
| 11 | 153.110 | 0.05 | | |
| 12 | 25.611 | 1.71 | 1.95906 | 17.5 |
| 13 | −129.369 | (Variable) | | |
| 14 (Stop) | ∞ | (Variable) | | |
| 15* | 10.177 | 2.68 | 1.55332 | 71.7 |
| 16* | −88.566 | 2.09 | | |
| 17 | 21.846 | 0.50 | 1.77250 | 49.6 |
| 18 | 9.532 | 0.45 | | |
| 19 | 12.727 | 0.50 | 1.80518 | 25.4 |
| 20 | 8.473 | 3.68 | 1.49700 | 81.5 |
| 21 | −23.919 | (Variable) | | |
| 22 | −112.478 | 0.35 | 1.77250 | 49.6 |
| 23 | 8.698 | 1.34 | 1.68893 | 31.1 |
| 24 | 28.333 | (Variable) | | |
| 25 | 20.423 | 2.76 | 1.65844 | 50.9 |
| 26 | −20.242 | 0.46 | 1.95906 | 17.5 |
| 27 | −37.496 | (Variable) | | |
| 28 | ∞ | 0.80 | 1.51633 | 64.1 |
| 29 | ∞ | 2.35 | | |
| Image surface | ∞ | | | |

Aspherical surface data

Fifteenth surface
K = 1.07318e−001 A4 = −1.03711e−004 A6 = −2.05066e−006
A8 = −2.64723e−008
Sixteenth surface
K = −4.32545e+001 A4 = 2.17212e−005 A6 = −2.22581e−006
A8 = −1.36334e−008

Various data
Zoom ratio 61.52

| | Wide angle | Intermediate | Telephoto |
|---|---|---|---|
| Focal length | 3.90 | 25.15 | 239.92 |
| F-number | 3.51 | 5.36 | 6.82 |
| Half angle of | 45.01 | 8.79 | 0.92 |
| view (degree) | | | |
| Image height | 3.18 | 3.88 | 3.88 |
| Total lens length | 97.36 | 125.35 | 148.46 |
| BF | 10.95 | 16.35 | 8.89 |
| d5 | 0.75 | 37.78 | 67.25 |
| d13 | 34.02 | 6.13 | 0.62 |
| d14 | 11.59 | 7.77 | 0.46 |
| d21 | 2.19 | 8.50 | 16.03 |
| d24 | 3.21 | 14.16 | 20.55 |
| d27 | 8.08 | 13.48 | 6.02 |

Zoom lens unit data

| Unit | First surface | Focal length |
|---|---|---|
| 1 | 1 | 86.69 |
| 2 | 6 | −8.44 |
| 3 | 14 | ∞ |
| 4 | 15 | 16.73 |
| 5 | 22 | −24.30 |
| 6 | 25 | 23.65 |
| 7 | 28 | ∞ |

| | |
|---|---|
| PgF1p | 0.5374 |
| PgF1n | 0.5824 |
| Image stabilization unit A | Second lens unit L2 |
| Image stabilization unit B | Third lens unit L3 |

Data at time of image blur correction

| | Wide angle | | Intermediate | | Telephoto | |
|---|---|---|---|---|---|---|
| Image blur correction | 3.734 | degrees | 0.859 | degree | 0.483 | degree |
| angle θ | | | | | | |
| Center-of-rotation | 150.000 | mm | 150.000 | mm | 150.000 | mm |
| position of image | | | | | | |
| stabilization unit A | | | | | | |
| Rotation angle of | 0.242 | degree | 0.111 | degree | 0.171 | degree |
| image stabilization | | | | | | |
| unit A | | | | | | |
| Shift component SA of | −0.633 | mm | −0.292 | mm | −0.447 | mm |
| image stabilization | | | | | | |
| unit A | | | | | | |
| Image stabilization | −0.4307 | | −1.5046 | | −4.6844 | |
| sensitivity TA of | | | | | | |
| image stabilization | | | | | | |
| unit A | | | | | | |
| Center-of-rotation | 4.000 | mm | 4.000 | mm | 4.000 | mm |
| position RB of image | | | | | | |
| stabilization unit B | | | | | | |
| Rotation angle TB of | 0.500 | degree | 0.833 | degree | 0.500 | degree |
| image stabilization | | | | | | |
| unit B | | | | | | |

### Embodiment 4

Unit mm
Surface data

| Surface number | | | | |
|---|---|---|---|---|
| i | ri | di | ndi | νdi |
| 1 | 41.041 | 0.78 | 1.84666 | 23.9 |
| 2 | 24.790 | 2.96 | 1.49700 | 81.5 |
| 3 | 850.388 | 0.13 | | |
| 4 | 26.594 | 2.02 | 1.71300 | 53.9 |
| 5 | 118.611 | (Variable) | | |
| 6 | −461.569 | 0.42 | 1.88300 | 40.8 |
| 7 | 5.651 | 2.88 | | |
| 8 | −18.826 | 0.40 | 1.80400 | 46.6 |
| 9 | 26.839 | 0.10 | | |
| 10 | 11.684 | 1.29 | 1.95906 | 17.5 |
| 11 | 56.561 | (Variable) | | |
| 12* | 8.631 | 1.30 | 1.62263 | 58.2 |
| 13* | −35.578 | 1.10 | | |
| 14 (Stop) | ∞ | 1.30 | | |
| 15 | 14.338 | 0.50 | 1.84666 | 23.9 |
| 16 | 6.806 | 0.47 | | |
| 17* | 51.167 | 1.40 | 1.55332 | 71.7 |
| 18* | −9.982 | (Variable) | | |
| 19 | −167.052 | 0.40 | 1.88300 | 40.8 |
| 20 | 26.898 | (Variable) | | |
| 21 | 15.969 | 2.54 | 1.77250 | 49.6 |
| 22 | −27.183 | 0.50 | 1.92286 | 18.9 |
| 23 | −69.836 | (Variable) | | |
| 24 | ∞ | 0.80 | 1.51633 | 64.1 |
| 25 | ∞ | 1.30 | | |
| Image surface | ∞ | | | |

Aspherical surface data

Twelfth surface
K = −2.92896e−001 A4 = −3.47222e−005 A6 = 7.02577e−005
A8 = −1.01803e−005 A10 = 6.45194e−007
Thirteenth surface
K = −6.07185e−002 A4 = 5.37200e−004 A6 = 8.49972e−005
A8 = −1.43643e−005 A10 = 9.41810e−007
Seventeenth surface
K = −3.18267e−001 A4 = 7.84938e−004 A6 = 6.99475e−005
A8 = −2.15031e−005 A10 = 1.50759e−006
Eighteenth surface
K = −6.23998e+000 A4 = −5.50992e−004 A6 = 6.72146e−005
A8 = −1.51202e−005 A10 = 9.30629e−007

Various data
Zoom ratio 21.59

| | Wide angle | Intermediate | Telephoto |
|---|---|---|---|
| Focal length | 4.57 | 18.24 | 98.62 |
| F-number | 3.61 | 4.80 | 7.31 |
| Half angle of | 41.74 | 12.05 | 2.20 |
| view (degree) | | | |
| Image height | 3.33 | 3.88 | 3.88 |
| Total lens length | 50.55 | 61.00 | 77.79 |
| BF | 8.53 | 14.77 | 4.44 |
| d5 | 0.70 | 12.31 | 24.44 |
| d11 | 16.72 | 4.65 | 0.45 |
| d18 | 1.71 | 5.52 | 10.85 |
| d20 | 2.41 | 3.26 | 17.13 |
| d23 | 6.71 | 12.95 | 2.61 |

Zoom lens unit data

| Unit | First surface | Focal length |
|---|---|---|
| 1 | 1 | 37.55 |
| 2 | 6 | −5.98 |
| 3 | 12 | 11.45 |
| 4 | 19 | −26.21 |
| 5 | 21 | 18.06 |
| 6 | 24 | ∞ |

| | |
|---|---|
| PgF1p | 0.5374 |
| PgF1n | 0.6205 |
| Image stabilization unit A | First lens unit L1 |
| Image stabilization unit B | Third lens unit L3 |

Data at time of image blur correction

| | Wide angle | | Intermediate | | Telephoto | |
|---|---|---|---|---|---|---|
| Image blur correction | 2.114 | degrees | 1.224 | degrees | 0.886 | degree |
| angle θ | | | | | | |
| Center-of-rotation | 60.000 | mm | 60.000 | mm | 60.000 | mm |
| position of image | | | | | | |
| stabilization unit A | | | | | | |
| Rotation angle of | −1.252 | degrees | −0.939 | degree | −0.626 | degree |
| image stabilization | | | | | | |
| unit A | | | | | | |
| Shift component SA of | 1.311 | mm | 0.983 | mm | 0.655 | mm |
| image stabilization | | | | | | |
| unit A | | | | | | |
| Image stabilization | 0.1217 | | 0.4859 | | 2.6266 | |
| sensitivity TA of | | | | | | |
| image stabilization | | | | | | |
| unit A | | | | | | |
| Center-of-rotation | 3.000 | mm | 3.000 | mm | 3.000 | mm |
| position RB of image | | | | | | |
| stabilization unit B | | | | | | |
| Rotation angle TB of | −0.500 | degree | 1.000 | degree | 1.000 | degree |
| image stabilization | | | | | | |
| unit B | | | | | | |

### Embodiment 5

Unit mm
Surface data

| Surface number | | | | |
|---|---|---|---|---|
| i | ri | di | ndi | νdi |
| 1 | 39.125 | 0.82 | 2.00100 | 29.1 |
| 2 | 21.596 | 3.50 | 1.49700 | 81.5 |
| 3 | 432.621 | 0.05 | | |
| 4 | 22.769 | 2.90 | 1.71300 | 53.9 |
| 5 | 196.845 | (Variable) | | |
| 6* | 266.572 | 0.40 | 1.85135 | 40.1 |
| 7* | 6.020 | 2.74 | | |
| 8 | −16.158 | 0.30 | 1.83481 | 42.7 |
| 9 | 16.632 | 0.17 | | |
| 10 | 11.237 | 1.40 | 1.95906 | 17.5 |
| 11 | 107.170 | (Variable) | | |
| 12 (Stop) | ∞ | −0.20 | | |
| 13* | 6.554 | 1.60 | 1.69350 | 53.2 |
| 14* | −14.393 | 0.05 | | |
| 15 | 4.380 | 1.40 | 1.51823 | 58.9 |
| 16 | 21.510 | 0.30 | 2.00100 | 29.1 |
| 17 | 3.570 | (Variable) | | |
| 18 | 11.612 | 2.35 | 1.63854 | 55.4 |
| 19 | −30.417 | 0.40 | 1.92286 | 18.9 |
| 20 | −113.804 | (Variable) | | |
| 21 | ∞ | 0.80 | 1.51633 | 64.1 |
| 22 | ∞ | 1.02 | | |
| Image surface | ∞ | | | |

Aspherical surface data

Sixth surface
K = −1.29020e+004 A4 = −6.61155e−005 A6 = 8.90248e−006
A8 = −1.99920e−007 A10 = 1.30290e−009
Seventh surface
K = 4.10002e−001 A4 = −2.96454e−004 A6 = 2.15115e−005
A8 = −5.78404e−007 A10 = 2.06787e−008
Thirteenth surface
K = 9.71537e−001 A4 = −1.55678e−003 A6 = −5.70950e−005
A8 = −5.32284e−006 A10 = −1.21314e−006
Fourteenth surface
K = 1.90506e+001 A4 = 2.30086e−004 A6 = 1.73488e−005
A8 = −9.87459e−006

Various data
Zoom ratio 17.04

| | Wide angle | Intermediate | Telephoto |
|---|---|---|---|
| Focal length | 4.64 | 14.99 | 78.98 |
| F-number | 3.92 | 5.34 | 7.31 |
| Half angle of | 40.66 | 14.69 | 2.73 |
| view (degree) | | | |
| Image height | 3.29 | 3.88 | 3.88 |
| Total lens length | 45.79 | 50.79 | 65.27 |
| BF | 3.71 | 10.45 | 4.18 |
| d5 | 0.48 | 9.67 | 21.96 |
| d11 | 16.18 | 5.60 | 0.48 |
| d17 | 7.24 | 6.89 | 20.48 |
| d20 | 2.16 | 8.90 | 2.63 |

Zoom lens unit data

| Unit | First surface | Focal length |
|---|---|---|
| 1 | 1 | 34.73 |
| 2 | 6 | −5.89 |
| 3 | 12 | 10.37 |
| 4 | 18 | 18.60 |
| 5 | 21 | ∞ |

| | |
|---|---|
| PgF1p | 0.5374 |
| PgF1n | 0.5994 |
| Image stabilization unit A | Second lens unit L2 |
| Image stabilization unit B | Third lens unit L3 |

Data at time of image blur correction

| | Wide angle | | Intermediate | | Telephoto | |
|---|---|---|---|---|---|---|
| Image blur correction | 2.429 | degrees | 1.416 | degrees | 0.880 | degree |
| angle θ | | | | | | |
| Center-of-rotation | 80.000 | mm | 80.000 | mm | 80.000 | mm |
| position of image | | | | | | |
| stabilization unit A | 0.246 | degree | 0.151 | degree | 0.262 | degree |
| Rotation angle of | | | | | | |
| image stabilization | | | | | | |
| unit A | | | | | | |
| Shift component SA of | −0.343 | mm | −0.211 | mm | −0.366 | mm |
| image stabilization | | | | | | |
| unit A | | | | | | |
| Image stabilization | −0.7074 | | −1.6150 | | −3.7690 | |
| sensitivity TA of | | | | | | |
| image stabilization | | | | | | |
| unit A | | | | | | |
| Center-of-rotation | 0.000 | mm | 0.000 | mm | 0.000 | mm |
| position RB of image | | | | | | |
| stabilization unit B | | | | | | |
| Rotation angle TB of | 0.833 | degree | −1.333 | degrees | 1.000 | degree |
| image stabilization | | | | | | |
| unit B | | | | | | |

TABLE 1

| Conditional | | | | | |
|---|---|---|---|---|---|
| Expression | Embodiment 1 | Embodiment 2 | Embodiment 3 | Embodiment 4 | Embodiment 5 |
| (1) | 0.094 | 0.115 | 0.070 | 0.116 | 0.131 |
| (2) | 4.277 | 2.017 | 1.035 | 1.129 | 1.136 |
| (3) | 0.045 | 0.051 | 0.035 | 0.381 | 0.075 |
| (4) | −0.575 | 0.240 | 0.404 | 0.494 | 0.000 |
| (5) | 1.283 | 1.008 | 1.035 | 1.129 | 1.136 |
| (6) | 0.825 | 1.006 | 1.071 | 0.946 | 1.235 |
| (7) | 8.727 | 7.563 | 10.876 | 21.583 | 5.328 |
| (8) | 0.383 | 0.324 | 0.361 | 0.381 | 0.440 |
| (9) | −0.000972 | −0.001317 | −0.000972 | −0.001441 | −0.001182 |
| (10) | −8.184 | −6.400 | −8.723 | −5.452 | −3.491 |
| (11) | 10.428 | 7.607 | 11.694 | 4.926 | 3.448 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-086634, filed Apr. 21, 2015, which is hereby incorporated by reference herein in its entirety.

1. A zoom lens, comprising, in order from an object side to an image side:
a first lens unit having a positive refractive power;
a second lens unit having a negative refractive power;
a third lens unit having a positive refractive power; and
a rear lens group including at least one lens unit,
wherein, during zooming from a wide angle end to a telephoto end, an interval between each pair of adjacent lens units is changed so that an interval between the first lens unit and the second lens unit is increased, an interval between the second lens unit and the third lens unit is reduced, and an interval between the third lens unit and the rear lens group is changed,
wherein the zoom lens includes an image stabilization unit A configured to move so as to have a component in a direction perpendicular to an optical axis during image blur correction, and an image stabilization unit B configured to be rotated around one of one point on the optical axis and one point near the optical axis along with the movement of the image stabilization unit A, and
wherein the following conditional expressions are satisfied:
0.01<|fB|/ft<0.35; and
0.85<|TBt|/θt<10.00,
where fB represents a focal length of the image stabilization unit B, ft represents a focal length of the zoom lens at the telephoto end, θt represents a maximum value of an image blur correction angle at the telephoto end, and TBt represents a rotation angle of the image stabilization unit B when the image blur correction at the image blur correction angle θt is performed at the telephoto end.

2. The zoom lens according to claim 1, wherein the following conditional expression is satisfied:
0.01<|fA|/ft<0.45,
where fA represents a focal length of the image stabilization unit A.

3. The zoom lens according to claim 1, wherein the following conditional expression is satisfied:
−1.00<RBt/LB<1.00,
where RBt represents a distance from a vertex of a lens surface closest to the object side of the image stabilization unit B to a center of rotation of the image stabilization unit B at the telephoto end, and LB represents a distance from the vertex of the lens surface closest to the object side to a vertex of a lens surface closest to the image side of the image stabilization unit B.

4. The zoom lens according to claim 1, wherein the following conditional expression is satisfied:
0.7<{tan⁻¹(SAt×TAt/ft)}/θt<1.4,
where SAt represents a shift component in the direction perpendicular to the optical axis of the image stabilization unit A when the image blur correction at the image blur correction angle θt is performed at the telephoto end, and TAt represents an image stabilization sensitivity of the image stabilization unit A at the telephoto end.

5. The zoom lens according to claim 1, wherein the following conditional expression is satisfied:
0.7<{tan⁻¹(SAw×TAw/fw)}/θw<1.4,
where θw represents a maximum value of an image blur correction angle at the wide angle end, SAw represents a shift component in the direction perpendicular to the optical axis of the image stabilization unit A when the image blur correction at the image blur correction angle θw is performed, TAw represents an image stabilization sensitivity of the image stabilization unit A at the wide angle end, and fw represents a focal length of the zoom lens at the wide angle end.

6. The zoom lens according to claim 1, wherein the following conditional expression is satisfied:
3.00<TAt/TAw,
where TAt represents an image stabilization sensitivity of the image stabilization unit A at the telephoto end, and TAw represents an image stabilization sensitivity of the image stabilization unit A at the wide angle end.

7. The zoom lens according to claim 1, wherein the following conditional expression is satisfied:
0.20<f1/ft<0.50,
where f1 represents a focal length of the first lens unit.

8. The zoom lens according to claim 1,
wherein the first lens unit includes positive lenses and negative lenses, and
wherein the following conditional expression is satisfied:
−0.002<(PgF1p−PgF1n)/(ν1p−ν1n),
where ν1p and PgF1p respectively represent an Abbe number and a partial dispersion ratio of a material of a positive lens G1p having a largest Abbe number of materials of the positive lenses included in the first lens unit, and ν1n and PgF1n respectively represent an Abbe number and a partial dispersion ratio of a material of a negative lens G1n having a lowest Abbe number of materials of the negative lenses included in the first lens unit.

9. The zoom lens according to claim 1, further comprising an aperture stop,
wherein the following conditional expression is satisfied:
−20.00<DSAw/fw<−2.00,
where DSAw represents a distance from the aperture stop to a vertex of a lens surface closest to the image side of the image stabilization unit A at the wide angle end, and fw represents a focal length of the zoom lens at the wide angle end.

10. The zoom lens according to claim 1, wherein the following conditional expression is satisfied:
2.00<DABw/fw<20.00,
where DABw represents a distance from a vertex of a lens surface closest to the image side of the image stabilization unit A to a vertex of a lens surface closest to the object side of the image stabilization unit B at the wide angle end, and fw represents a focal length of the zoom lens at the wide angle end.

11. The zoom lens according to claim 1,
wherein the rear lens group consists of a fourth lens unit having a positive refractive power,
wherein the fourth lens unit is configured to move along a locus that is convex toward the object side during zooming from the wide angle end to the telephoto end,
wherein the image stabilization unit A is the second lens unit, and
wherein the image stabilization unit B is the third lens unit.

12. The zoom lens according to claim 1,
wherein the rear lens group consists, in order from the object side to the image side, of a fourth lens unit having a negative refractive power, and a fifth lens unit having a positive refractive power,
wherein each of the fourth lens unit and the fifth lens unit is configured to move along a locus that is different from those of other lens units during zooming,
wherein the image stabilization unit A is the second lens unit, and
wherein the image stabilization unit B is the third lens unit.

13. The zoom lens according to claim 1,
wherein the rear lens group consists, in order from the object side to the image side, of a fourth lens unit having a negative refractive power, and a fifth lens unit having a positive refractive power,
wherein each of the fourth lens unit and the fifth lens unit is configured to move along a locus that is different from those of other lens units during zooming,
wherein the image stabilization unit A is the second lens unit, and
wherein the image stabilization unit B is the fourth lens unit.

14. The zoom lens according to claim 1,
wherein the rear lens group consists, in order from the object side to the image side, of a fourth lens unit having a negative refractive power, and a fifth lens unit having a positive refractive power,
wherein each of the fourth lens unit and the fifth lens unit is configured to move along a locus that is different from those of other lens units during zooming,
wherein the image stabilization unit A is the first lens unit, and
wherein the image stabilization unit B is the third lens unit.

15. An image pickup apparatus, comprising:
a zoom lens, comprising, in order from an object side to an image side:
a first lens unit having a positive refractive power;
a second lens unit having a negative refractive power;
a third lens unit having a positive refractive power; and
a rear lens group including at least one lens unit,
wherein, during zooming from a wide angle end to a telephoto end, an interval between each pair of adjacent lens units is changed so that an interval between the first lens unit and the second lens unit is increased, an interval between the second lens unit and the third lens unit is reduced, and an interval between the third lens unit and the rear lens group is changed,
wherein the zoom lens includes an image stabilization unit A configured to move so as to have a component in a direction perpendicular to an optical axis during image blur correction, and an image stabilization unit B configured to be rotated around one of one point on the optical axis and one point near the optical axis along with the movement of the image stabilization unit A, and
wherein the following conditional expressions are satisfied:
0.01<|fB|/ft<0.35; and
0.85<|TBt|/θt<10.00,
where fB represents a focal length of the image stabilization unit B, ft represents a focal length of the zoom lens at the telephoto end, θt represents a maximum value of an image blur correction angle at the telephoto end, and TBt represents a rotation angle of the image stabilization unit B when the image blur correction at the image blur correction angle θt is performed at the telephoto end; and
an image pickup element configured to receive an image formed by the zoom lens.
